(19) United States
(12) Patent Application Publication
(10) Pub. No.: US 2025/0301296 A1
(43) Pub. Date: Sep. 25, 2025

(54) METHODS AND APPARATUS FOR MANAGING A CONDITION IN USER EQUIPMENT IN A WIRELESS NETWORK

(71) Applicant: SAMSUNG ELECTRONICS CO., LTD., Suwon-si (KR)

(72) Inventors: Aman AGARWAL, Bangalore (IN); Lalith KUMAR, Bangalore (IN); Sidhant JAIN, Bangalore (IN); Dinesh Rooparam CHOUDHARY, Bangalore (IN); Mahmoud WATFA, Staines (GB); Vishal YADAV, Bangalore (IN); Utsav SINHA, Bangalore (IN)

(21) Appl. No.: 19/090,169

(22) Filed: Mar. 25, 2025

(30) Foreign Application Priority Data
Mar. 25, 2024 (IN) 202441023358
May 14, 2024 (IN) 202441037938
Mar. 12, 2025 (IN) 202441023358

(51) Int. Cl. H04W 4/90; H04W 48/18; H04W 84/04

(52) U.S. Cl. CPC H04W 4/90; H04W 48/18; H04W 84/042

(57) ABSTRACT

The disclosure relates to a 5G or 6G communication system for supporting a higher data transmission rate. Embodiments disclose methods for managing a condition in a UE. The method includes initiating a timer for disaster wait range; in case that the UE is switched off while the timer is running, and that the UE is switched on after the UE is switched off, wherein a universal subscriber identity module (USIM) in the UE remains as same, and the UE selects a public land mobile network (PLMN) for a disaster roaming: identifying a first time remaining for the timer for timeout at switch off, identifying a second time related to a time between switching off and switching on, and determining whether to restart the timer based on the first time and the second time.

### CROSS REFERENCE TO RELATED APPLICATIONS

This application is based on and claims priority under 35 U.S.C. §119 to Indian patent application Ser. No. 202441023358 filed on Mar. 25, 2024, Indian Patent Application No. 202441037938 filed on May 14, 2024, and Indian Patent Application No. 202441023358 filed on Mar. 12, 2025, in the Indian Intellectual Property Office, the disclosures of which are incorporated by reference herein in their entirety.

### BACKGROUND

### 1. Field

Embodiments disclosed herein relate to wireless communication networks, and more particularly to methods and systems for managing a condition in a user equipment (UE) in a wireless network.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Generally, a UE and a wireless communication network may support minimization of service interruption (MINT), which aims to enable the UE to obtain service from a public land mobile network (PLMN). The PLMN offers disaster roaming services when a disaster condition applies to the UE based on the UE determined PLMN with a disaster condition. The purpose of the MINT is to minimize service interruptions for a user associated with the UE, when the wireless network to which they are subscribed cannot provide service due to a disaster, such as a fire, cyclone or the like, by enabling them to obtain service from other networks while simultaneously protecting other networks from congestion.

When the UE supports the MINT, the following parameters, if available, are stored in a non-volatile memory of a mobile equipment (ME) as specified in Annex C of the 3GPP TS 23.122 and are retained when the UE enters a fifth generation mobility management (5GMM)-DEREGISTERED state: the indication of whether disaster roaming is enabled in the UE, the indication of the applicability of “lists of PLMN(s) to be used in a disaster condition” provided by a Visited public land mobile network (VPLMN); one or more “lists of PLMN(s) to be used in a disaster condition,” and the disaster roaming wait range and disaster return wait range provisioned by the network. Annex C of the 3GPP TS 23.122 specifies the conditions under which the stored parameters, including the indication of whether disaster roaming is enabled in the UE, the indication of applicability of “lists of PLMN(s) to be used in the disaster condition” provided by the VPLMN, the one or more “lists of PLMN(s) to be used in the disaster condition,” the disaster roaming wait range, and the disaster return wait range in the ME, are deleted.

On selecting the PLMN for the disaster roaming as specified in third generation partnership project (3GPP) Technical Specification (TS) 23.122, if the UE does not have a stored disaster roaming wait range, the UE may perform a registration procedure for the disaster roaming services on the selected PLMN as described in the TS 23.122. If the UE has a stored disaster roaming wait range, the UE may generate a random number within the disaster roaming wait range and start a timer with the generated random number. While the timer is running, the UE may not initiate registration on the selected PLMN, except when the UE needs to request an emergency protocol data unit (PDU) session. In such a case, the UE may initiate the registration procedure, set the 5GS registration type Information Element (IE) to “emergency registration” in the REGISTRATION REQUEST message, and keep the timer running. Upon expiration of the timer, if the UE does not have an emergency PDU session, the UE may perform the registration procedure for the disaster roaming services as described in 3GPP standard specification, provided if the UE is still camped on the selected PLMN. If the UE has the emergency PDU session when the timer expires, the registration procedure for the disaster roaming services, as described in 3GPP standard specification, may be performed after the release of the emergency PDU session, provided that the UE is still camped on the selected PLMN.

Upon determining that a disaster condition has ended and that the UE may perform PLMN selection as specified in 3GPP TS 23.122:

a) if the UE does not have a stored disaster return wait range, the UE may perform a registration procedure on the selected PLMN; and
b) if the UE has a stored disaster return wait range, the UE may generate a random number within the disaster return wait range and start a timer with the generated random number value. While the timer is running, the UE may not initiate registration on the selected PLMN except if the UE needs to request an emergency PDU session, in which case the UE may initiate the registration procedure, set the 5GS registration type IE to “emergency registration” in the REGISTRATION REQUEST message and keep the timer running. Upon expiration of the timer, if the UE does not have an emergency PDU session, the UE may perform a registration procedure if still camped on the selected PLMN. If the UE has an emergency PDU session when the timer expires, the registration procedure as described in 3GPP standard specification may be performed after the release of the emergency PDU session, if the UE is still camped on the selected PLMN.

In an example, the term “PLMN D” (or “PLMN-D)” refers to a network subject to a disaster condition, while “PLMN A” (or “PLMN-A”) refers to a network that remains operational and is not affected by the disaster condition. The PLMN-A may provide disaster roaming services to the users of PLMN-D (i.e., Disaster Inbound Roamers of PLMN-D). The terms “disaster-based service,” “disaster roaming service,” and “disaster inbound roaming” are used interchangeably in the patent disclosure and have the same meaning. Similarly, the terms “disaster situation” and “disaster condition” are interchangeable in the patent disclosure and have the same meaning.

The terms “PLMN A” and “PLMN-A” are used interchangeably in the patent disclosure and have the same meaning. Likewise, the terms “UE” and “MS” are used interchangeably in the patent disclosure.

The term or method where “UE is registering for the disaster roaming service” or “UE is registered for the disaster roaming service” may refer to a situation or condition, but not restricted or limited to, where the UE sets or indicates the fifth generation system (5GS) Registration type IE to at least one of a “disaster roaming initial registration” and a “disaster roaming mobility registration updating” in the REGISTRATION REQUEST message. The term area/location/geographical area are used in this embodiment may refer to any of cell/cell ID, TAC/TAI, PLMN, MCC/MNC, Latitude/longitude, CAG cell or any geographical location/coordinate. The solutions explained in this embodiment are applicable to any (but not limited to) of the RAT(s) as defined in this embodiment. The Network used in this embodiment could be any 5G/EUTRAN core network entities like AMF/SMF/MME/UPF or the network could be any (but not limited to) 5G/EUTRAN RAN Entity like eNodeB (eNB) or gNodeB (gNB) or NG-RAN etc.

For an instance, consider that the UE or MS was registered/camped to PLMN1 (for e.g., PLMN-D) for normal services when disaster conditions were hit. The UE was configured with disaster roaming wait range and disaster return wait range. When the disaster condition is triggered, the UE selects PLMN2 (for e.g., on behalf of PLMNI i.e., PLMN-D) to register for disaster roaming services. The UE starts the wait timer (e.g., disaster roaming wait timer) for a random number generated within the “disaster roaming wait range,” and registers on the PLMN2 after expiry of the wait timer. The registered PLMN (for e.g., RPLMN) of the UE is PLMN2. The UE is switched OFF and switched ON. At switch on, the RPLMN is a PLMN on which the UE was registered for the disaster roaming services (for e.g., PLMN2), and the UE is not registered via non-3GPP access connected to a 5GCN and no allowable PLMN is available and the MS selects the RPLMN (for e.g., PLMN2) or its equivalent PLMN for disaster roaming services. The MS may generate the random number within the disaster roaming wait range and start a timer (for e.g., disaster roaming wait timer) set to the generated random number. While the timer is running, the MS may not initiate registration with the exception of performing an initial registration for the emergency services, in the selected PLMN (for e.g., RPLMN or PLMN2). while performing the initial registration for the emergency services in the selected PLMN, the MS may keep the timer running. Upon expiration of the timer, if the MS does not have the emergency PDU session, the MS may initiate registration, if still camped on the selected PLMN (for e.g., PLMN2). The term “PLMN1” can be referred to as “first PLMN.” The term “PLMN2” can be referred to as “second PLMN” and the term “PLMN3” can be referred to as “third PLMN.”

When the UE performs PLMN search/selection after switch-ON, and selects the PLMN on which the UE was registered for disaster roaming services (for e.g., RPLMN or PLMN2) before switch-OFF., The UE un-necessarily runs the timer (for e.g., Disaster roaming wait timer) for the random number within the disaster roaming wait range and waits for the timer to expire. The UE may try to initiate registration even though the UE was registered on the selected PLMN (for e.g., PLMN2) for the disaster roaming services prior to switch-OFF and switch-ON. Also, the UE has already run the disaster roaming wait timer once for the selected PLMN. This leads to unnecessary delay for the UE to get the disaster roaming services on the selected PLMN after switch-OFF and switch-ON.

Hence, there is a need in the art for solutions which will overcome the above-mentioned drawback(s), among others.

The principal object of the embodiments herein is to disclose methods and systems for managing a disaster condition in a UE in a wireless communication network.

Another object of the embodiments herein is to handle a Minimization of service interruption (MINT) wait timer in the wireless communication network, when the UE is moving from normal service to disaster roaming service or when the UE is moving from disaster roaming service to normal service.

Another object of embodiments herein is to handle the UE when switching on or recovering from a lack of coverage, if the Registered PLMN (RPLMN) is a PLMN with which the MS was previously registered for disaster roaming services, and optionally, if the MS is not registered via non-3GPP access connected to the 5G Core Network (CN), no other allowable PLMN is available, and/or an NG-RAN cell of the RPLMN or any other PLMN broadcasts the disaster-related indication or a “list of one or more PLMN(s) with disaster conditions for which disaster roaming services are offered by the available PLMN,” optionally including the MS-determined PLMN with the disaster condition.

Another object of the embodiments herein is to specify the UE behaviour for using disaster timers (i.e., Disaster Roaming wait range and Disaster Return wait range) when the UE is switched off/On or when USIM is removed/re-inserted and the UE selects a PLMN for disaster roaming or a UE determined PLMN with disaster condition.

### SUMMARY

The embodiment discloses a method for managing a disaster condition in a user equipment (UE). The method includes receiving an indication of the disaster condition to initiate a timer for a disaster roaming wait range. The method includes initiating or running the timer for the disaster roaming wait range. The method includes storing a remaining time of the timer for the disaster roaming wait range, on the UE detecting at least one first event. The method includes determining whether the remaining time of the timer for the disaster roaming wait range has elapsed after at least one first event, on the UE detecting at least one second event. The method includes selecting a public land mobile network (PLMN) providing a disaster roaming service. Further, the method includes determining, by the UE, the time elapsed between at least one first event and at least one second event. The method includes restarting the timer for the disaster roaming wait range with the computed remaining value by subtracting the time elapsed between at least one first event and at least one second event from the previously stored remaining time of the timer for the disaster roaming wait range when the previously stored timer value has not elapsed between at least one first event and at least one second event.

The embodiments disclose a method for managing disaster condition in a UE. The method includes receiving an indication that the disaster condition has ended. The method includes initiating or running a timer for a disaster return wait range. The method includes storing a remaining time of the timer for the disaster return wait range, on the UE detecting at least one first event. The method includes determining whether a previously stored remaining time of the timer for the disaster return wait range has elapsed after at least one first event, on the UE detecting the at least one second event. The method includes selecting a public land mobile network (PLMN) for registration. The method includes determining the time elapsed between at least one first event and at least one second event. The method includes restarting the timer for the disaster return wait range with the computed remaining value by subtracting a time elapsed between at least one first event and at least one second event from the previously stored remaining time of the timer for the disaster return wait range when the previously stored timer value has not elapsed between at least one first event and at least one second event.

The embodiments disclose a user equipment (UE), comprising: a processor; a memory; and a disaster condition handling controller, coupled with the processor and the memory. The disaster condition handling controller receives an indication of the disaster condition to initiate a timer for a disaster roaming wait range. The disaster condition handling controller initiates or runs the timer for the disaster roaming wait range. The disaster condition handling controller stores a remaining time of the timer for the disaster roaming wait range, on the UE detecting at least one first event. The disaster condition handling controller determines whether the stored remaining time of the disaster roaming wait range has elapsed after at least one first event, on the UE detecting the at least one second event. The disaster condition handling controller selects a public land mobile network (PLMN) providing a disaster roaming service. The disaster condition handling controller selects a PLMN providing a disaster roaming service. The disaster condition handling controller restarts the timer for the disaster roaming wait range with the computed remaining value by subtracting the time elapsed between at least one first event and at least one second event from the previously stored remaining time of the timer for the disaster roaming wait range when the previously stored timer value has not elapsed between at least one first event and at least one second event.

The embodiments disclose a user equipment (UE), comprising: a processor; a memory; and a disaster condition handling controller, coupled with the processor and the memory. The disaster condition handling controller receives an indication that the disaster condition has ended. The disaster condition handling controller initiates a timer for a disaster return wait range. The disaster condition handling controller stores a remaining time of the timer for the disaster return wait range, on the UE detects at least one first event. The disaster condition handling controller determines whether a previously stored remaining time of the timer for the disaster return wait range has elapsed after at least one first event, on the UE detecting the at least one second event. The disaster condition handling controller selects a public land mobile network (PLMN) for registration. The disaster condition handling controller determines the time elapsed between at least one first event and at least one second event. The disaster condition handling controller restarts the timer for the disaster return wait range with the computed remaining value by subtracting a time elapsed between at least one first event and at least one second event from the previously stored remaining time of the timer for the disaster return wait range when the previously stored timer value has not elapsed between at least one first event and at least one second event.

The embodiments disclose a method by a user equipment (UE) (102) for managing a condition in a wireless network, the method comprising: initiating, by the UE (102), a timer for the disaster roaming wait range; in case that the UE is switched off while the timer is running, and that the UE is switched on after the UE is switched off, wherein a universal subscriber identity module (USIM) in the UE remains as same, and the UE selects a public land mobile network (PLMN) for a disaster roaming: identifying a first time remaining for the timer for timeout at switch off, identifying a second time related to a time between switching off and switching on, and determining whether to restart the timer based on the first time and the second time.

The embodiments disclose a user equipment (UE), comprising: a transceiver; a memory; and at least one processor coupled to the transceiver and the memory, and configured to: initiate a timer for disaster wait range, in case that the UE is switched off while the timer is running, and that the UE is switched on after the UE is switched off, wherein a universal subscriber identity module (USIM) in the UE remains as same and the UE selects a public land mobile network (PLMN) for a disaster roaming: identify a first time remaining for the timer for timeout at switch off, identify a second time related to a time between switching off and switching on, and determine whether to restart the timer based on the first time and the second time.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the scope thereof, and the embodiments herein include all such modifications.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF FIGURES

Embodiments herein are illustrated in the accompanying drawings, throughout which like reference letters indicate corresponding parts in the various figures. The embodiments herein will be better understood from the following description with reference to the following illustratory drawings. Embodiments herein are illustrated by way of examples in the accompanying drawings, and in which:

FIG. 1 illustrates a scenario wherein a UE attempts to register with a PLMN for a disaster roaming according to existing art;

FIG. 2 illustrates a scenario which is not clear whether the UE can immediately register in the PLMN after power up when prior to power-off the UE was running a timer based on the disaster roaming wait range according to existing art;

FIG. 3 illustrates a scenario which is not clear whether the UE can immediately register in the PLMN after power up when prior to power-off the UE was running the timer based on the disaster return wait range according to existing art;

FIG. 4 illustrates a scenario which is not clear whether the UE can immediately register in the PLMN after power up when prior to power-off the UE was running the timer based on the disaster return wait range according to existing art;

FIGS. 5A and 5B illustrate operations for managing the disaster condition in the UE in a wireless communication network according to embodiments as disclosed herein;

FIG. 6 illustrates a UE according to embodiments as disclosed herein;

FIG. 7 illustrates a scenario wherein the registered PLMN (RPLMN) is a PLMN with which the MS was registered for disaster roaming services (i.e., the UE supports MINT and the RPLMN is a forbidden PLMN for the UE on which the UE was registered for the disaster roaming services) according to embodiments as disclosed herein;

FIG. 8 illustrates a disaster timer handling after the power off of the UE according to the embodiments as disclosed herein;

FIG. 9 illustrates a disaster timer handling after power off of the UE according to embodiments as disclosed herein; and

FIG. 10 illustrates a disaster timer handling after power off of the UE according to embodiments as disclosed herein;

FIG. 11 illustrates a method for managing the disaster condition in the UE in the network while receiving an indication that disaster condition has occurred according to embodiments as disclosed herein; and

FIG. 12 illustrates a method for managing the disaster condition in the UE in the network while receiving an indication that disaster condition has ended according to embodiments as disclosed herein.

### DETAILED DESCRIPTION

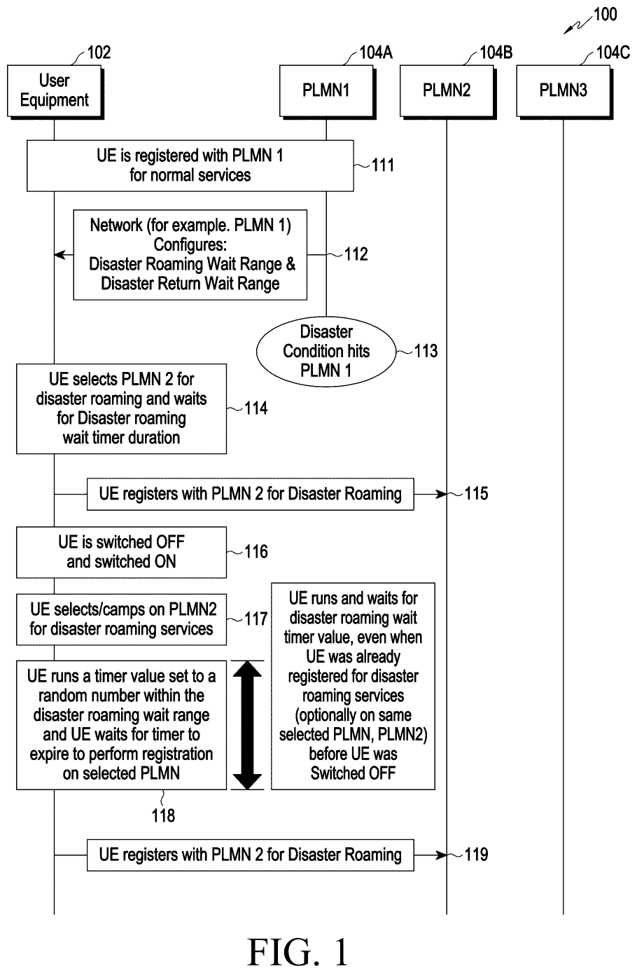

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising,” “having” and “including” are to be construed as open-ended terms unless otherwise noted.

The words/phrases “exemplary,” “example,” “illustration,” “in an instance,” “and the like,” “and so on,” “etc.,” “etcetera,” “e.g.,”, “i.e.,” are merely used herein to mean “serving as an example, instance, or illustration.” Any embodiment or implementation of the present subject matter described herein using the words/phrases “exemplary,” “example,” “illustration,” “in an instance,” “and the like,” “and so on,” “etc.,” “etcetera,” “e.g.,” “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

Embodiments herein disclose methods and systems for managing a disaster condition in a UE in a wireless communication network.

Embodiments herein disclose methods and systems for specifying the UE behavior for using the disaster timers (such as disaster roaming wait range timer and disaster return wait range timer). When the UE is switched OFF/ON or when the universal subscriber identity module (USIM) is removed/re-inserted and the UE selects a PLMN for disaster roaming or the UE determined PLMN with disaster condition.

In an embodiment, if the UE is switched OFF when the timer for disaster roaming wait range is running, the UE may behave as follows when the UE is switched ON, the universal subscriber identity module (USIM) in the UE remains the same and the UE selects a PLMN for disaster roaming services: let t1 be the time remaining for the timer for the disaster roaming wait range timeout at switched OFF and let t be the time elapsed between switched OFF and switched ON. If t1 is greater than t, then the timer may be restarted with the value t1−t. If t1 is equal to or less than t, then the timer need not be restarted. If the UE is not capable of determining t, then the UE may restart the timer with the value t1.

After power up of the UE if timer for disaster roaming wait range is re-started, the UE may wait for the timer to expire before the UE can perform registration in a PLMN for the disaster roaming services. Otherwise, the UE may perform registration immediately.

In another embodiment, the UE may not re-start the timer for the disaster roaming wait range after power up, i.e., the timer may not be continued, and the UE may perform registration immediately if the UE selects the PLMN for the disaster roaming services.

When the UE is switched OFF when the timer for disaster return wait range is running, the UE may behave as follows when the UE is switched ON, the Universal Subscriber Identity Module (USIM) in the UE remains the same and the UE selects the UE determined PLMN with disaster condition: let t1 be the time remaining for the timer for disaster return wait range timeout at switched OFF and let t be the time elapsed between switched OFF and switched ON. If t1 is greater than t, then the timer may be restarted with the value t1−t. If t1 is equal to or less than t, then the timer need not be restarted. If the UE is not capable of determining t, then the UE may restart the timer with the value t1. Otherwise, the UE may not restart the timer and perform an immediate registration.

After power up of the UE if the timer for the disaster return wait range is re-started, the UE may wait for the timer to expire before the UE can perform registration in the UE determined PLMN with disaster condition. Otherwise, the UE may perform registration immediately.

In another embodiment, the UE may not re-start the timer for disaster return wait range after power up, i.e., the timer may not be continued, and the UE may perform registration immediately if the UE selects the PLMN.

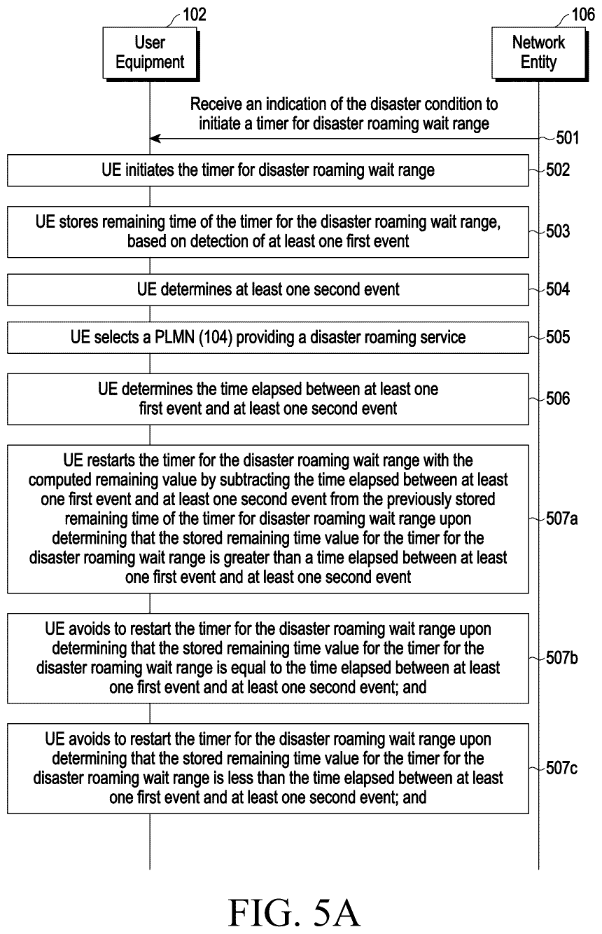

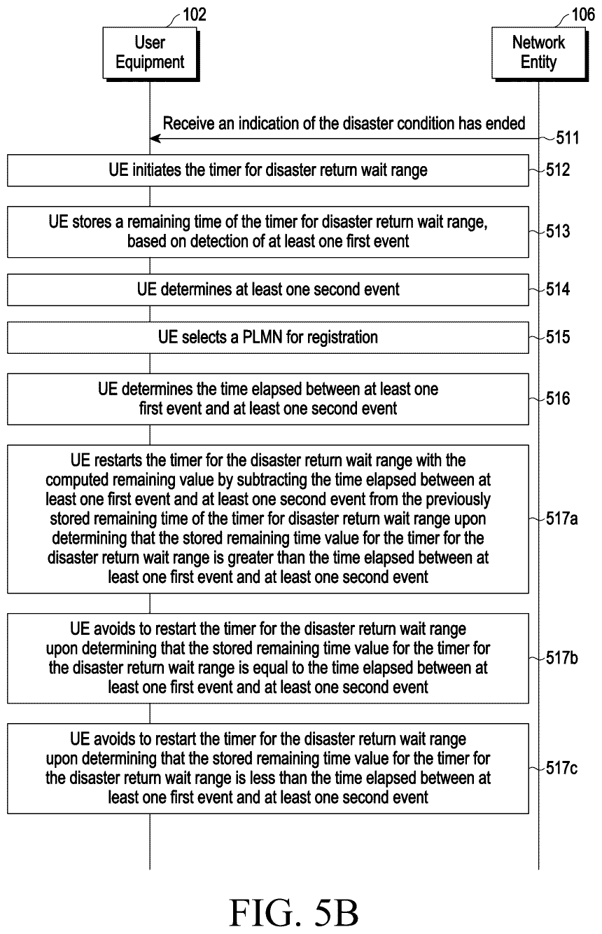

Referring now to the drawings, and more particularly to FIGS. 5A through 10, where similar reference characters denote corresponding features consistently throughout the figures, there are shown at least one embodiment.

The following methods and abbreviations have been referred to herein:

### 3GPP: Third Generation Partnership Project

### 5GC: 5G Core

### 5GCN: 5G Core Network

### 5GMM: 5G Mobility Management

### 5G-RG: 5G Residential Gateway

### 5GS: 5G System

### 5GSM: 5GS Session Management

### AMF: Access and Mobility Management Function

### eNB: Evolved Node-B

eNPN: Enhanced Non-Public Networks
gNB: Next generation Node-B

### GPS: Global Positioning System

### GSM: Global System for Mobile Communication

### HPLMN: Home Public Land Mobile Network

### ME: Mobile Equipment

MINT: Minimization of service interruption

### MME: Mobility Management Entity

### MNC: Mobile Network Code

MS: Mobile Station. The present document makes no distinction between MS and UE.

### NAS: Non-Access Stratum

### NR: New Radio

### RAT: Radio Access Technology

### RPLMN: Registered Public Land Mobile Network

### RRC: Radio Resource Control

### SIM: Subscriber Identity Module

### UE: User Equipment

### USIM: Universal Subscriber Identification Module

### VPLMN: Visited Public Land Mobile Network

Visited PLMN (VPLMN): This is a PLMN different from the HPLMN (if the EHPLMN list is not present or is empty) or different from an EHPLMN (if the EHPLMN list is present).
Allowable PLMN: In the case of an MS operating in MS operation mode A or B, this is a PLMN that is not in the list of “forbidden PLMNs” in the MS. In the case of an MS operating in MS operation mode C or an MS not supporting A/Gb mode and not supporting Iu mode, this is a PLMN which is not in the list of “forbidden PLMNs” and not in the list of “forbidden PLMNs for GPRS service” in the MS.
Available PLMN: PLMN(s) in the given area which is/are broadcasting capability to provide wireless communication services to the UE 102.
Camped on a cell: The MS (ME if there is no SIM) has completed the cell selection/reselection process and has chosen a cell from which the MS plans to receive all available services. Note that the services may be limited, and that the PLMN or the SNPN may not be aware of the existence of the MS (ME) within the chosen cell.
EHPLMN: Any of the PLMN entries contained in the Equivalent HPLMN list.
Equivalent HPLMN list: To allow provision for multiple HPLMN codes, PLMN codes that are present within this list may replace the HPLMN code derived from the IMSI for PLMN selection purposes. This list is stored on the USIM and is known as the EHPLMN list. The EHPLMN list may also contain the HPLMN code derived from the IMSI. If the HPLMN code derived from the IMSI is not present in the EHPLMN list then it may be treated as a Visited PLMN for PLMN selection purposes.
Home PLMN: This is a PLMN where the MCC and MNC of the PLMN identity match the MCC and MNC of the IMSI.
Registered PLMN (RPLMN): This is the PLMN on which certain LR (location registration which is also called as registration procedure) outcomes have occurred. In a shared network the RPLMN is the PLMN defined by the PLMN identity of the CN operator that has accepted the LR.
Registration: This is the process of camping on a cell of the PLMN or the SNPN and doing any necessary LRs.
UPLMN: PLMN/access technology combination in the “User Controlled PLMN Selector with Access Technology” data file in the SIM (in priority order).
OPLMN: PLMN/access technology combination in the “Operator Controlled PLMN Selector with Access Technology” data file in the SIM (in priority order) or stored in the ME (in priority order).
Disaster Condition: This is the condition that a government decides when to initiate and terminate, e.g., a natural disaster. When this condition applies, users may have the opportunity to mitigate service interruptions and failures.
Disaster Inbound Roamer: A user that (a) cannot get service from the PLMN it may normally be served by, due to failure of service during a Disaster Condition, and (b) can register with other PLMNs.
Disaster Roaming: This is the special roaming policy that applies during a Disaster Condition. PLMN with Disaster Condition: A PLMN to which a Disaster Condition applies.
Registered for disaster roaming services: A UE 102 is considered as “registered for disaster roaming services” when it has successfully completed initial registration or mobility registration for disaster roaming services.

Examples of NAS messages can be, but not limited to, REGISTRATION REQUEST message; DEREGISTRATION REQUEST message; SERVICE REQUEST message; CONTROL PLANE SERVICE REQUEST; IDENTITY REQUEST; AUTHENTICATION REQUEST; AUTHENTICATION RESULT; AUTHENTICATION REJECT; REGISTRATION REJECT; REGISTRATION ACCEPT; DEREGISTRATION ACCEPT; SERVICE REJECT; SERVICE ACCEPT; UE 102 CONFIGURATION UPDATE command; UE 102 PARAMETERS UPDATE command, and so on.

The term 5GMM sublayer states in this embodiment are at least one of the below:

### 1) 5GMM-NULL

### 2) 5GMM-DEREGISTERED

a) 5GMM-DEREGISTERED.NORMAL-SERVICE
b) 5GMM-DEREGISTERED.LIMITED-SERVICE
c) 5GMM-DEREGISTERED.ATTEMPTING-REGISTRATION
d) 5GMM-DEREGISTERED.PLMN-SEARCH
e) 5GMM-DEREGISTERED.NO-SUPI
f) 5GMM-DEREGISTERED.NO-CELL-AVAILABLE
g) 5GMM-DEREGISTERED.eCALL-INACTIVE
h) 5GMM-DEREGISTERED.INITIAL-REGISTRATION-NEEDED

### 3) 5GMM-REGISTERED-INITIATED

### 4) 5GMM-REGISTERED

a) 5GMM-REGISTERED.NORMAL-SERVICE
b) 5GMM-REGISTERED.NON-ALLOWED-SERVICE
c) 5GMM-REGISTERED.ATTEMPTING-REGISTRATION-UPDATE
d) 5GMM-REGISTERED.LIMITED-SERVICE
e) 5GMM-REGISTERED.PLMN-SEARCH
f) 5GMM-REGISTERED.NO-CELL-AVAILABLE
g) 5GMM-REGISTERED.UPDATE-NEEDED

### 5) 5GMM-DEREGISTERED-INITIATED

### 6) 5GMM-SERVICE-REQUEST-INITIATED

In this embodiment, the term EMM sublayer states are at least one of the below:

### 1) EMM-NULL

### 2) EMM-DEREGISTERED

a) EMM-DEREGISTERED.NORMAL-SERVICE
b) EMM-DEREGISTERED.LIMITED-SERVICE
c) EMM-DEREGISTERED.ATTEMPTING-TO-ATTACH
d) EMM-DEREGISTERED.PLMN-SEARCH
e) EMM-DEREGISTERED.NO-IMSI
f) EMM-DEREGISTERED.ATTACH-NEEDED
g) EMM-DEREGISTERED.NO-CELL-AVAILABLE
h) EMM-DEREGISTERED.eCALL-INACTIVE

### 3) EMM-REGISTERED-INITIATED

### 4) EMM-REGISTERED

a) EMM-REGISTERED.NORMAL-SERVICE
b) EMM-REGISTERED.ATTEMPTING-TO-UPDATE
c) EMM-REGISTERED.LIMITED-SERVICE
d) EMM-REGISTERED.PLMN-SEARCH
e) EMM-REGISTERED.UPDATE-NEEDED
f) EMM-REGISTERED.NO-CELL-AVAILABLE
g) EMM-REGISTERED.ATTEMPTING-TO-UPDATE-MM
h) EMM-REGISTERED.IMSI-DETACH-INITIATED

### 5) EMM-DEREGISTERED-INITIATED

### 6) EMM-TRACKING-AREA-UPDATING-INITIATED

### 7) EMM-SERVICE-REQUEST-INITIATED

The term RAT as defined in this embodiment can be one of the following: NG-RAN, 5G, 4G, 3G, 2G, EPS, 5GS, NR, NR in unlicensed bands, NR (LEO) satellite access, NR (MEO) satellite access, NR (GEO) satellite access, NR (OTHERSAT) satellite access, NR RedCap, E-UTRA, E-UTRA in unlicensed bands, NB-IoT, WB-IoT, LTE-M, and so on.

5GS registration types can be initial registration, mobility registration updating, periodic registration updating, emergency registration, SNPN onboarding registration, disaster roaming initial registration, disaster roaming mobility registration updating, and so on.

Not setting the registration type to disaster roaming initial registration or disaster roaming mobility registration updating means 5GS registration type is set to value other than “disaster roaming initial registration” or “disaster roaming mobility registration updating” at least one of initial registration, mobility registration updating, periodic registration updating, emergency registration, SNPN onboarding registration, and so on.

PLMN selection as per 23.122 without RPLMN:

The MS selects and attempts registration on any PLMN/access technology combinations, if available and allowable, in the following order:
either the HPLMN (if the EHPLMN list is not present or is empty) or the highest priority EHPLMN that is available (if the EHPLMN list is present);
each PLMN/access technology combination in the “User Controlled PLMN Selector with Access Technology” data file in the SIM (in priority order);
each PLMN/access technology combination in the “Operator Controlled PLMN Selector with Access Technology” data file in the SIM (in priority order) or stored in the ME (in priority order);
other PLMN/access technology combinations with received high quality signal in random order; and
other PLMN/access technology combinations in order of decreasing signal quality. PLMN selection as per 23.122 with RPLMN:

The MS selects and attempts registration on any PLMN/access technology combinations, if available and allowable, in the following order:
either the RPLMN or the Last registered PLMN;
either the HPLMN (if the EHPLMN list is not present or is empty) or the highest priority EHPLMN that is available (if the EHPLMN list is present);
   each PLMN/access technology combination in the “User Controlled PLMN Selector with Access Technology” data file in the SIM (in priority order);
each PLMN/access technology combination in the “Operator Controlled PLMN Selector with Access Technology” data file in the SIM (in priority order) or stored in the ME (in priority order);
other PLMN/access technology combinations with received high quality signal in random order; and
other PLMN/access technology combinations in order of decreasing signal quality.

In the description, PLMN D or PLMN-D is subject to disaster (i.e., PLMN-D is the PLMN with disaster condition) and PLMN A or PLMN-A is alive and not subject to disaster. PLMN-A may provide disaster roaming service to the users of the PLMN-D (i.e., to the Disaster Inbound roamers of the PLMN-D).

The terms disaster-based service, disaster roaming service and disaster inbound roaming are used interchangeably in this embodiment and have the same meaning.

The terms disaster situation and disaster condition are used interchangeably in this embodiment and have the same meaning.

The terms PLMN D and PLMN-D are used interchangeably in this embodiment and have the same meaning.

The terms PLMN A and PLMN-A are used interchangeably in this embodiment and have the same meaning.

The terms UE and MS are used interchangeably in this embodiment and have the same meaning.

The terms switch on, switch-on, switched-on, switched on, power-on, power on, power up, power-up, powered-up, powered up, powered-on and powered on are used interchangeably and have the same meaning.

The terms switch off, switch-off, switched-off, switched off, power-off, power off, power down, power-down, powered-down, powered down, powered-off and powered off are used interchangeably and have the same meaning.

The term or method where “UE is registering for the disaster roaming service” or “UE is registered for the disaster roaming service” may refer to a situation or condition, but not restricted or limited to, where the UE sets or indicates the Fifth Generation System (5GS) Registration type IE to at least one of a “disaster roaming initial registration” and a “disaster roaming mobility registration updating” in the REGISTRATION REQUEST message.

The term area/location/geographical area are used in this embodiment may refer to any of cell/cell ID, TAC/TAI, PLMN, MCC/MNC, Latitude/longitude, CAG cell or any geographical location/coordinate.

The solutions explained in this embodiment are applicable to any (but not limited to) of the RAT(s) as defined in this embodiment.

The Network used in this embodiment could be any 5G/EUTRAN Core Network Entities like AMF/SMF/MME/UPF or the Network could be any (but not limited to) 5G/EUTRAN RAN Entity like eNodeB (eNB) or gNodeB (gNB) or NG-RAN etc.

The methods, issues or solutions disclosed in this embodiment are explained using NR access or NG-RAN Access Technology as an example and is not restricted or limited to NR access only. However, the solutions provided in this embodiment are also applicable for E-UTRAN access Technology, NB (Narrow Band)-S1 mode or WB (Wide Band)-S1 mode via E-UTRAN access and/or NB-IoT (NarrowBand Internet of Things) or WB-IoT (WideBand Internet Of Things) Access/Architecture.

The solutions which are defined for NR (5GC) are also applicable to legacy RATs like E-UTRA/LTE, the corresponding CN entities needs to be replaced by LTE entities for e.g., AMF with MME, g-nodeB with e-nodeB, UDM with HSS etc. But principles of the solutions remain the same.

The Network used in this embodiment is explained using any 5G Core Network Function for e.g., AMF. However, the network could be any 5G/EUTRAN Core Network Entities like AMF/SMF/MME/UPF or the Network could be any 5G/EUTRAN RAN Entity like eNodeB (eNB) or gNodeB (gNB) or NG-RAN etc.

The messages used or indicated in this embodiment are shown as an example. The messages could be any signalling messages between the UE 102 and the Network Functions/Entities or between different Network functions/entities.

The terms camp and register are used interchangeably and have the same meaning.

The term area as used in this embodiment may refer to any one of cell/cell ID, TAC/TAI, PLMN, MCC/MNC, Latitude/longitude, any CAG/CAG identifier or any geographical location/coordinate.

For the list of possible NAS messages please refer to 3GPP TS 24.501 or 3GPP TS 24.301, for a list of AS messages please refer to 3GPP TS 38.331 or 3GPP TS 36.331

The cause names in this embodiment are for illustration purposes and can have any name. The non access stratum (NAS) messages and access stratum (AS) messages described in this embodiment are only for illustration purpose can be any NAS or AS messages as per defined protocol between the UE 102 and AMF/MME or the UE 102 and gNB (NG-RAN/any RAN node)/eNB.

The solutions which are defined for NR (5GC) are also applicable to legacy RATs like E-UTRA/LTE, the corresponding CN entities needs to be replaced by LTE entities for e.g., AMF with MME, g-nodeB with e-nodeB, UDM with HSS etc. But principles of the solutions remain the same.

An example list of NAS messages can be, but not limited to, REGISTRATION REQUEST message; DEREGISTRATION REQUEST message; SERVICE REQUEST message; CONTROL PLANE SERVICE REQUEST; IDENTITY REQUEST; AUTHENTICATION REQUEST; AUTHENTICATION RESULT; AUTHENTICATION REJECT; REGISTRATION REJECT; DEREGISTRATION ACCEPT; SERVICE REJECT; SERVICE ACCEPT, and so on.

The Network used in this embodiment is explained using any 5G Core Network Function for e.g., AMF. However, the network could be any 5G/EUTRAN Core Network Entities like AMF/SMF/MME/UPF or the Network could be any 5G/EUTRAN RAN Entity like eNodeB (eNB) or gNodeB (gNB) or NG-RAN etc.

The messages used or indicated in this embodiment are shown as an example. The messages could be any signalling messages between the UE 102 and the Network Functions/Entities or between different Network functions/entities.

The term area/location/geographical area used in this embodiment may refer to any of cell/cell ID, TAC/TAI, PLMN, MCC/MNC, Latitude/longitude, CAG cell or any geographical location/coordinate.

The methods, issues or solutions disclosed in this embodiment are explained using NR access or NG-RAN Access Technology as an example and are not restricted or limited to NR access only. However, the solutions provided in this embodiment are also applicable for E-UTRAN access Technology, NB (Narrow Band)-S1 mode or WB (Wide Band)-S1 mode via E-UTRAN access and/or NB-IOT (NarrowBand Internet Of Things) or WB-IOT (WideBand Internet Of Things) Access/Architecture.

The solutions which are defined for NR (5GC) are also applicable to legacy RATs like E-UTRA/LTE, the corresponding CN entities needs to be replaced by LTE entities for e.g., AMF with MME, g-nodeB with e-nodeB, UDM with HSS etc. But principles of the solutions remain the same.

The Network used in this embodiment is explained using any 5G Core Network Function (for e.g., AMF). However, the network could be any 5G/EUTRAN Core Network Entities like AMF/SMF/MME/UPF or the Network could be any 5G/EUTRAN RAN Entity like eNodeB (eNB) or gNodeB (gNB) or NG-RAN etc.

The messages used or indicated in this embodiment are shown as an example. The messages could be any signalling messages between the UE 102 and the Network Functions/Entities or between different Network functions/entities.

The terms camp and register are used interchangeably and have the same meaning.

The term area as used in this embodiment may refer to any of cell/cell ID, TAC/TAI, PLMN, MCC/MNC, Latitude/longitude, any CAG/CAG identifier or any geographical location/coordinate.

For the list of possible NAS messages please refer to 3GPP TS 24.501 or 3GPP TS 24.301, for list of AS messages please refer to 3GPP TS 38.331 or 3GPP TS 36.331

The cause names in this embodiment are for illustration purpose and can have any name. The non access stratum (NAS) messages and access stratum (AS) messages described in this embodiment are only for illustration purpose can be any NAS or AS messages as per defined protocol between the UE 102 and AMF/MME or the UE 102 and gNB (NG-RAN/any RAN node)/eNB.

The phrases “UE is registering for the disaster roaming service” or “UE is registered for the disaster roaming service” may refer to situations where the UE sets or indicates the Fifth Generation System (5GS) Registration type information element (IE) to at least one of the following in the REGISTRATION REQUEST message: “disaster roaming initial registration” or “disaster roaming mobility registration updating.” The terms “area,” “location,” and “geographical area,” as used in this embodiment, may refer to any of the following: cell/cell ID, TAC/TAI, PLMN, MCC/MNC, latitude/longitude, CAG cell, or any geographical location/coordinate. The solutions explained in this embodiment are applicable to, but not limited to, any of the RAT(s) defined herein. The network used in this embodiment could be any 5G/EUTRAN Core Network entity, such as Access and Mobility Management Function (AMF), Session Management Function (SMF), Mobility Management Entity (MME), or User Plane Function (UPF). Alternatively, the network could be any 5G/EUTRAN RAN entity, such as an eNodeB (eNB), gNodeB (gNB), or NG-RAN, among others.

FIG. 1 depicts an example scenario, wherein the UE 102 is attempting to register with the PLMN for disaster roaming. In step 111, the UE 102 or MS is registered to the PLMN1 104A (for e.g., PLMN-D) for the normal services. In step 112, the UE 102 is configured (for e.g., by PLMN1 104A or by the Home PLMN (for e.g., HPLMN of the UE 102) or by any Network/Network Entity) with disaster roaming wait range and/or disaster return wait range. In step 113, the PLMN1 104A faces disaster condition or Disaster condition hits the PLMN1 104A. The UE 102 supports MINT services. In step 114, the UE 102 selects PLMN2 104B for getting the disaster roaming services (for e.g., on behalf of PLMN1 104A or PLMN-D). Upon selecting a PLMN for disaster roaming (for e.g., PLMN2 104B), if there is a disaster roaming wait range stored in the UE 102, the UE 102 may generate the random number within the disaster roaming wait range and start the timer (for e.g., disaster roaming wait timer) set to the generated random number. While the timer is running, the MS may not initiate registration with the exception of performing the initial registration for emergency services, in the selected PLMN (for e.g., PLMN2 104B). If performing an initial registration for emergency services in the selected PLMN, the MS may keep the timer running. Upon expiration of the timer, in step 115, if the MS does not have the emergency PDU session, the MS may initiate registration, if still camped on the selected PLMN (for e.g., PLMN2 104B). The UE 102 registers on PLMN2 104B for disaster roaming services. The Registered PLMN (for e.g., RPLMN) of the UE 102 is PLMN2 104B. In step 116, the UE 102 is switched OFF and switched ON.

In step 117, at switch ON, the RPLMN of the UE 102 is a PLMN on which the MS was registered for the disaster roaming services (for e.g., PLMN2 104B), and the MS is not registered via the non-3GPP access connected to the 5GCN and allowable PLMN is not available and the MS selects the RPLMN (for e.g., PLMN2 104B) or its equivalent PLMN for the disaster roaming services. For example, when the UE 102 performs PLMN search/selection after switch-ON, and the UE 102 selects the PLMN on which the UE 102 was registered for the disaster roaming services (for e.g., RPLMN or PLMN2 104B) before switch-OFF). If there is a disaster roaming wait range stored in the UE 102, in step 118, the UE 102 may generate the random number within the disaster roaming wait range and start the timer (for e.g., disaster roaming wait timer) set to the generated random number. While the timer is running, the MS may not initiate registration with the exception of performing an initial registration for emergency services, in the selected PLMN (for e.g., PLMN2). while performing the initial registration for the emergency services in the selected PLMN, the MS may keep the timer running. The UE 102 un-necessarily runs the timer (for e.g., Disaster roaming wait timer) for the random number within the disaster roaming wait range and waits for the timer to expire to initiate registration even though the UE 102 was registered on the selected PLMN (for e.g., PLMN2 104B) for the disaster roaming services prior to switch-OFF and switch-ON and has already run the disaster roaming wait timer once for the selected PLMN. Upon expiration of the timer, in step 119, if the MS does not have the emergency PDU session, the MS may initiate registration, if still camped on the selected PLMN (for e.g., PLMN2 104B). The UE 102 registers on the PLMN2 104B for the disaster roaming services. Hence, leads to an unnecessary delay for the UE 102 to get disaster roaming services on the selected PLMN after switch-OFF and switch-ON.

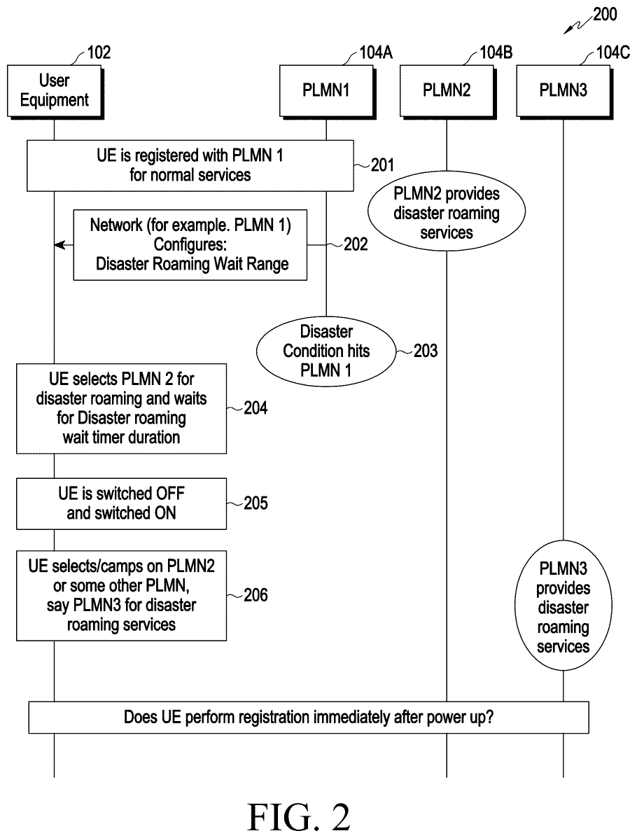

FIG. 2 illustrates a scenario which is not clear whether the UE 102 can immediately register in the PLMN after power up, prior to power-off the UE 102 that was running a timer based on the disaster roaming wait range according to existing art.

The UE or MS 102 was registered/camped to the PLMNI 104A (for e.g., PLMN-D) for the normal services when the disaster conditions was hit. The UE 102 was configured with disaster roaming wait range. When the disaster condition was triggered, the UE 102 selects PLMN2 104B (for e.g., on behalf of PLMN1 104A i.e., PLMN-D) for the disaster roaming services. The UE 102 starts the wait timer (e.g., disaster roaming wait timer) for the random number generated within the “disaster roaming wait range” before the UE 102 can register in PLMN2 104B. The UE 102 is switched OFF and switched ON in the meantime. At switch on, the UE 102 finds and selects the PLMN2 104B or finds any other PLMN such as PLMN3 104C that can provide disaster roaming services. The situation is not clear, whether the UE 102 can immediately register in PLMN2 104B or PLMN3 104C after power up, since prior to power-off the UE 102 was running the timer based on the disaster roaming wait range. Hence, when the UE 102 had powered off while the UE 102 was waiting to register in the PLMN providing the disaster roaming services, and after power up, the UE 102 finds and camps in the PLMN providing disaster roaming services, the UE 102 behaviour with respect to the registration needs to be addressed.

Pre-condition, in which both PLMN2 104B and PLMN3 104C provide disaster roaming services. At step 201, the UE 102 is registered with PLMN1 104A for the normal services. At step 202, the network (for e.g., PLMN1 104A) configures the disaster roaming wait range. At step 203, disaster condition hits in PLMN1 104A. At step 204, the UE 102 selects PLMN2 104B for disaster roaming services and waits for Disaster roaming wait timer duration. At step 205, the UE 102 is switched OFF and switched ON. At step 206, the UE 102 selects/camps on PLMN2 104B or some other PLMN say PLMN3 104C for disaster roaming services. Hence, whether the UE performs registration immediately after power-up for e.g. on PLMN2 104B or some other PLMN say PLMN3 104C for disaster roaming services is unknown, which is uncertain.

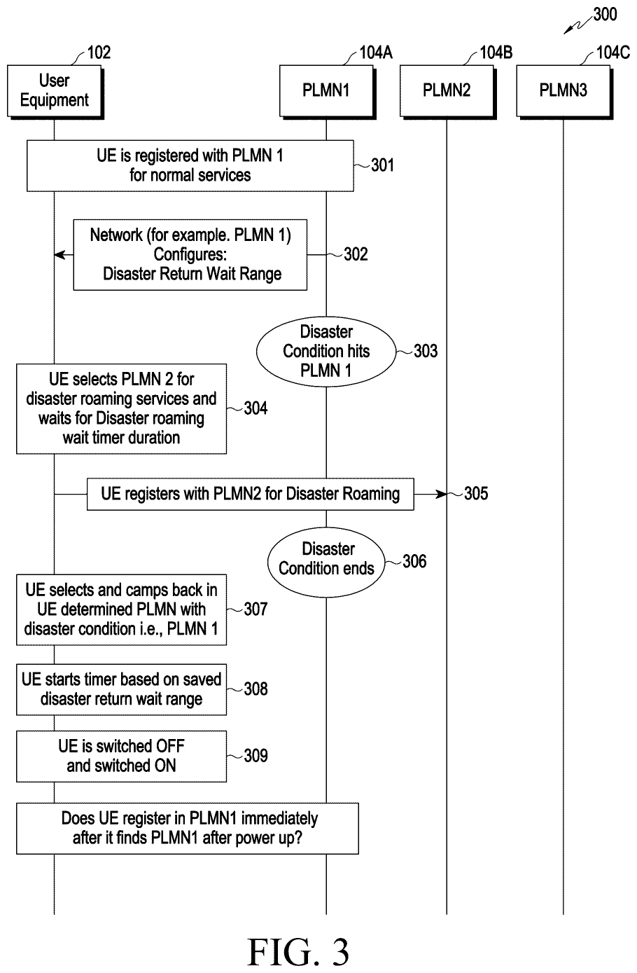

FIG. 3 illustrates a scenario which is not clear whether the UE 102 can immediately register in the PLMN after power-on, when prior to power-off the UE 102 was running the timer based on the disaster return wait range, according to existing art. Pre-condition such as PLMN1 104A is the UE determined PLMN with disaster condition, and PLMN3 104C is any other allowable PLMN.

The UE 102 or MS was registered/camped to the PLMN1 104A (for e.g. PLMN-D) for normal services when disaster conditions was hit. The UE 102 was configured with the disaster return wait range. When the disaster condition was triggered, the UE 102 selects the PLMN2 104B (for e.g. on behalf of PLMN1 104A i.e., PLMN-D) for disaster roaming services. The UE 102 registers for disaster roaming services in PLMN2 104B. The Disaster condition ends, the UE 102 performs PLMN Selection as per TS 23.122 and finds and selects MS determined PLMN with disaster condition, in this case PLMN1 104A. The UE 102 starts timer, the value of which is based on a random number based on the stored disaster return wait range. The UE 102 waits for the mentioned time duration before it can register back in PLMN1 104A. The UE 102 is switched OFF and switched ON in the meantime.

At switch on, the UE 102 finds and selects the UE determined PLMN for disaster condition i.e. PLMN1 104A. It is not clear whether the UE 102 can immediately register in PLMN1 104A or PLMNX after power up, since prior to power-off the UE 102 was running a timer based on the disaster return wait range. Hence, when the UE 102 had powered off while waiting to register in the MS determined PLMN with disaster condition, and after power up the UE 102 finds and camps in MS determined PLMN with disaster condition or some other PLMN, the UE 102 behavior with respect to registration needs to be addressed.

As illustrated in FIG. 3, at step 301, the UE 102 is registered with PLMN1 104A for normal services. At step 302, the network (for e.g. PLMN1 104A) configures disaster return wait range. At step 303, the disaster condition hits in PLMN1 104A. At step 304, the UE 102 selects PLMN2 104B for disaster roaming services and waits for Disaster roaming wait timer duration. At step 305, the UE 102 registers in PLMN2 104B for disaster roaming services. At step 306, the disaster condition ends. At step 307, the UE 102 selects and camps back in the UE determined PLMN with disaster condition, i.e. PLMN1 104A. At step 308, the UE 102 starts timer based on saved disaster return wait range. At step 309, the UE 102 is switched OFF and switched ON. Hence, whether the UE 102 performs registration immediately after the power-up operation, after the UE 102 finds PLMN1 104A is not known, which is uncertain.

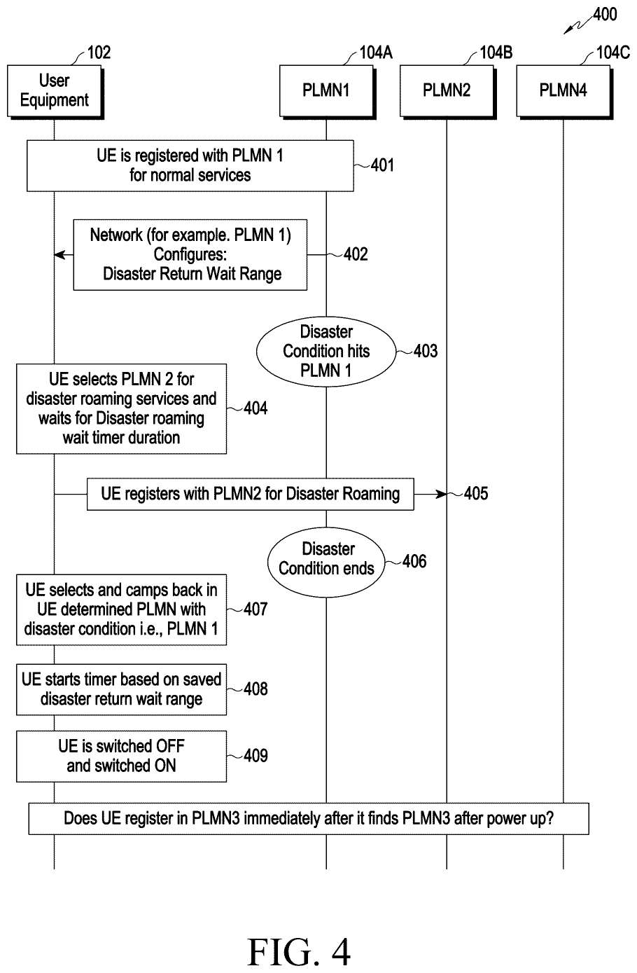

FIG. 4 illustrates a scenario which is not clear whether the UE 102 can immediately register in the PLMN after power up, prior to power-off the UE 102 was running the timer based on the disaster return wait range, according to existing art. Pre-condition such as the PLMN1 104A is the UE determined PLMN with disaster condition, PLMN3 104C is any other allowable PLMN. At step 401, the UE 102 is registered with PLMN1 104A for normal services. At step 402, the network (for e.g., PLMN1 104A) configures disaster return wait range. At step 403, disaster condition hits in PLMN1 104A. At step 404, the UE 102 selects PLMN2 104B for disaster roaming services and waits for Disaster roaming wait timer duration. At step 405, the UE 102 registers in PLMN2 104B for disaster roaming services. At step 406, the disaster condition ends. At step 407, the UE 102 selects and camps back in the UE determined PLMN with disaster condition, i.e., PLMN1 104A. At step 408, the UE 102 starts timer based on saved disaster return wait range. At step 409, the UE is switched OFF and switched ON. Hence, whether the UE 102 performs registration immediately after the power-up operation, after the UE 102 finds PLMN3 104C is not known, which is uncertain.

FIGS. 5A and 5B are example diagrams for managing the disaster condition in the UE 102 in a wireless communication network. FIG. 5A, focuses on managing disaster conditions in the UE 102 by implementing a disaster roaming wait range timer. In step 501, the UE 102 receives an indication of a disaster condition from a network entity 106, which triggers the UE 102 to initiate a timer for disaster roaming wait range. In step 502, the UE 102 initiates or runs the timer for disaster roaming wait range. In step 503, the UE 102 stores the remaining time of the timer for disaster roaming wait range, based on detection of at least one first event. The events may include but not limited to, the UE 102 being switched OFF, a loss of network coverage, or the removal of the Universal Subscriber Identity Module (USIM). Storing the remaining time of the timer for disaster roaming wait range is essential because it allows the UE 102 to compute the required timer value and resume disaster roaming process without resetting the timer completely upon restarting.

In step 504, the UE 102 determines at least one second event. The events may include but not limited to, the UE 102 being switched ON (for e.g. when the USIM remains the same), a recovery from loss of network coverage, or the reinsertion of the same USIM in the UE.

In step 505, the UE 102 selects a public land mobile network (PLMN) 104 that offers disaster roaming services based on the received indication. The selection is performed based on the conditions, which may include but not limited to network availability, network priority, and disaster-specific configurations to ensure that the UE 102 connects to a stable and appropriate PLMN during the disaster condition. Further, the UE 102 does not prematurely attempt to register with the selected PLMN before the designated wait time expires, so as to prevent unnecessary congestion in the network.

In step 506, the UE 102 determines the time elapsed between at least one first event (for e.g. switch off of the UE 102) and at least one second event (for e.g. switch On of the UE 102).

In step 507a, the UE restarts the timer for the disaster roaming wait range with the computed remaining value by subtracting the time elapsed between at least one first event and at least one second event from the previously stored remaining time of the timer for disaster roaming wait range upon determining that the stored remaining time value for the timer for the disaster roaming wait range is greater than a time elapsed between at least one first event and at least one second event.

In step 507b, the UE avoids restarting the timer for the disaster roaming wait range upon determining that the stored remaining time value for the timer for the disaster roaming wait range is equal to the time elapsed between at least one first event and at least one second event.

In step 507c, the UE avoids restarting the timer for the disaster roaming wait range upon determining that the stored remaining time value for the timer for the disaster roaming wait range is less than the time elapsed between at least one first event and at least one second event.

In an embodiment, if the previously stored timer value has not elapsed between at least one first event (for e.g. switch off of the UE 102) and at least one second event (for e.g. switch On of the UE 102), the UE 102 restarts the timer for the disaster roaming wait range with the computed remaining value. The computation involves subtracting the time that has elapsed between at least one first event (for e.g. switch off of the UE 102) and at least one second event (for e.g. switch On of the UE 102), from the previously stored remaining time of the timer for the disaster roaming wait range. By recalculating (or recomputing) and resuming the timer instead of resetting the timer, the UE 102 ensures a seamless transition.

The embodiment herein provides an efficient way for the UE 102 to manage disaster roaming by optimizing PLMN selection, maintaining the integrity of the disaster roaming wait range timer, and preventing premature registration attempts.

Further, the UE 102 determines whether the stored remaining timer value (t1) of the timer for the disaster roaming wait range is greater than the elapsed time (t) between at least one first event (for e.g. switch off of the UE 102) and at least one second event (for e.g. switch On of the UE 102). If t1 is greater than t, the timer is restarted with the updated value (t1−t). If t1 equals t, the timer is not restarted. If t1 is less than t, the timer is also not restarted. In that scenario, the UE 102 cannot determine the elapsed time (t) between at least one first event (for e.g. switch off of the UE 102) and at least one second event (for e.g. switch On of the UE 102), the UE 102 restarts the timer for disaster return wait range with the previously stored remaining timer value (t1) of the timer for the disaster roaming wait range.

The embodiment herein ensures that the UE 102 prohibits registration with the selected PLMN 104 until the timer for the disaster roaming wait range has expired (for e.g. the UE 102 does not initiate registration in the selected PLMN 104 till the timer for the disaster roaming wait range is running). The indication of the disaster condition triggers the above-mentioned procedures, which may be received by the UE 102 from multiple sources, may include, but not limited to a network, a network entity 106, a broadcast message, or a preconfigured setting in the UE 102.

FIG. 5B focusses on managing the transition of the UE 102 back to normal service after the disaster condition has ended. In step 511, the UE 102 receives an indication that the disaster condition has ended. In step 512, the UE 102 initiates or runs the timer for disaster return wait range. In step 513, the UE 102 stores the remaining time of the timer for disaster return wait range, based on detection of at least one first event. The events may include, but not limited to situations such as the UE being switched off, a loss of network coverage, the USIM being removed. Storing the remaining time value of the timer for disaster return wait range ensures that the UE 102 is able to compute the required timer value and resume disaster return process without resetting the timer completely upon restarting, so as to allow the UE 102 to resume its recovery process accurately.

In step 514, the UE 102 determines at least one second event. The events may include but not limited to, the UE 102 being switched ON (for e.g. when the USIM remains the same), a recovery from loss of network coverage, or the reinsertion of the same USIM in the UE.

In step 515, the UE 102 selects a public land mobile network (PLMN) 104 that offers normal roaming services based on the received indication. The selection is performed based on the conditions, which may include but not limited to network availability, network priority, and UE-specific configurations to ensure that the UE 102 connects to a stable and appropriate PLMN after the disaster condition has ended. The selected PLMN can be at least one of: the UE (102) determined PLMN with disaster condition, an allowable PLMN for the UE (102) and the PLMN providing normal services to the UE (102). Further, the UE 102 does not prematurely attempt to register with the selected PLMN before the designated wait time expires, so as to prevent unnecessary congestion in the network. This step is essential in preventing the UE 102 from prematurely attempting to connect to the selected PLMN before the designated waiting period has expired.

In step 516, the UE 102 determines the time elapsed between at least one first event (for e.g. switch off of the UE 102) and at least one second event (for e.g. switch On of the UE 102)

In Step 517a, the UE restarts the timer for the disaster return wait range with the computed remaining value by subtracting the time elapsed between at least one first event and at least one second event from the previously stored remaining time of the timer for disaster return wait range upon determining that the stored remaining time value for the timer for the disaster return wait range is greater than the time elapsed between at least one first event and at least one second event.

In step 517b, the UE avoids restarting the timer for the disaster return wait range upon determining that the stored remaining time value for the timer for the disaster return wait range is equal to the time elapsed between at least one first event and at least one second event.

In step 517c, the UE avoids restarting the timer for the disaster return wait range upon determining that the stored remaining time value for the timer for the disaster return wait range is less than the time elapsed between at least one first event and at least one second event.

If the previously stored timer value has not elapsed between at least one first event (for e.g. switch off of the UE 102) and at least one second event (for e.g. switch On of the UE 102), the UE 102 computes a remaining timer value by subtracting the elapsed time between at least one first event (for e.g. switch off of the UE 102) and at least one second event (for e.g. switch On of the UE 102) from the previously stored remaining time of the timer for the disaster return wait range. The UE 102 restarts the disaster return wait range timer with the computed remaining timer value by subtracting the time elapsed between at least one first event (for e.g. switch off of the UE 102) and at least one second event (for e.g. switch On of the UE 102) from the previously stored remaining time of the timer for the disaster return wait range when the previously stored timer value has not elapsed between at least one first event (for e.g. switch off of the UE 102) and at least one second event (for e.g. switch On of the UE 102).

Further, the UE 102 determines whether the stored remaining timer value (t1) of the timer for the disaster return wait range timer is greater than the elapsed time (t) between at least one first event (for e.g. switch off of the UE 102) and at least one second event (for e.g. switch On of the UE 102). If t1 is greater than t, the timer is restarted with the updated value (t1−t). If t1 equals t, the timer is not restarted. If t1 is less than t, the timer is also not restarted. In that scenario, the UE 102 cannot determine the elapsed time (t) between at least one first event (for e.g. switch off of the UE 102) and at least one second event (for e.g. switch On of the UE 102), the UE 102 restarts the disaster return wait range timer with the previously stored timer value (t1).

Thereby, ensuring that the UE 102 prohibits registration with the selected PLMN 104 until the timer for disaster return wait range has expired (for e.g. the UE 102 does not initiate registration in the selected PLMN 104 till the timer for the disaster return wait range is running). The UE 102 receives the indication of the end of the disaster condition from many sources, may include, but not limited to the network entity 106, the broadcast message, or the preconfigured setting in the UE 102. This indication serves as the trigger for the UE 102 to begin the process of returning to the normal service.

Upon recovery from the disaster or a period of no network coverage, the UE 102 checks whether the RPLMN is stored and determines whether the RPLMN was previously used for disaster return services. Ensures that the UE 102 does not attempt to return to the RPLMN that was not originally associated with disaster recovery.

Additionally, the UE 102 determines whether the selected PLMN 104 has recovered from the disaster condition before initiating the timer for disaster return wait range. This step ensures that the UE 102 does not attempt to return to the network 106 that is still facing disruptions. By verifying the recovery status of the PLMN 104, the provided method ensures that the transition back to the RPLMN occurs only when the network 106 is stable and capable of providing service.

Therefore, effectively manages the return of the UE 102 to its original network after a disaster, ensuring that network congestion is minimized and allowing for a smooth transition without unnecessary disruptions. Hence, the provided method prevents premature registration attempts with networks that are still recovering, while also ensuring that the UE 102 resumes the normal service in a timely and controlled manner.

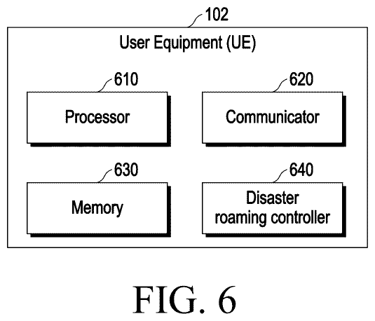

FIG. 6 illustrates a UE 102, according to embodiments as disclosed herein. The UE 102 comprises a processor 610, a communicator 620, a memory 630, and a disaster roaming controller 640. The processor 610 is coupled with the communicator 620, the memory 630, and the disaster roaming controller 640.

When the UE 102 detects that the disaster condition has occurred, the disaster roaming controller 640 is responsible for initiating the timer for disaster roaming wait range upon receiving the indication that the UE 102 needs to switch to the alternate public land mobile network (PLMN) 104 since disaster condition has occurred. Further, the UE 102 may initiate or run the timer for the disaster roaming wait range. The UE 102 may store a remaining time of the timer for the disaster roaming wait range, on the UE 102 detecting at least one first event. The UE 102 may determine whether the remaining time of the timer for the disaster roaming wait range has elapsed after at least one first event, on the UE 102 detecting at least one second event. The communicator 620 enables the UE 102 to select and register with the available PLMN 104 providing the disaster roaming services. In the present disclosure, the term ‘communicator’ may be interchangeably referred to as a ‘transceiver’. The UE 102 may determine the time elapsed between at least one first event and at least one second event. If the UE 102 is switched off or the USIM is removed, the memory 630 stores the remaining time of the disaster roaming wait range timer. Upon restarting, the processor 610 calculates the timer for the disaster roaming wait range with the computed remaining value by subtracting the time elapsed between at least one first event and at least one second event from the previously stored remaining time of the timer for the disaster roaming wait range when the previously stored timer value has not elapsed between at least one first event and at least one second event. The first event may be at least one of: the UE 102 is switched off, loss of network coverage and when the universal subscriber identity module (USIM) is removed from the UE 102. The at least one second event is at least one of: the UE (102) is switched on and the USIM in the UE (102) remains the same; recovery from network coverage loss and when the same USIM is reinserted in the UE.

If the remaining time exceeds the elapsed time, the disaster roaming controller 640 restarts the disaster roaming wait range timer with the updated value. Additionally, the UE 102 prohibits registration with the selected PLMN 104 until the timer has expired.

In the case when the disaster condition ends, the disaster roaming controller 640 manages the transition of the UE 102 back to the normal services by receiving an indicating that the disaster condition has ended. The UE 102 may initiate a timer for a disaster return wait range.

The UE 102 may store a remaining time of the timer for the disaster return wait range, on the UE detecting at least one first event. The UE 102 may determine whether a previously stored remaining time of the timer for the disaster return wait range has elapsed after at least one first event, on the UE (102) detecting the at least one second event. The UE 102 may select a public land mobile network (PLMN) for registration.

The UE 102 may determine the time elapsed between at least one first event and at least one second event and restart the timer for the disaster return wait range with the computed remaining value by subtracting a time elapsed between at least one first event and at least one second event from the previously stored remaining time of the timer for the disaster return wait range when the previously stored timer value has not elapsed.

In an embodiment, the processor 610 performs similar calculations to determine if the timer may be restarted. The communicator 620 enables the UE 102 to verify whether the previously selected PLMN 104 has recovered before attempting to re-register. The memory 630 ensures that the stored RPLMN information is used to determine whether the UE 102 was previously registered for the disaster roaming services. If no other PLMN 104 is available for registration, the disaster roaming controller 640 ensures that the UE 102 selects the RPLMN and prevents unintended timer activation by restricting the generation of a random number within the disaster roaming wait range.

Thereby ensuring a smooth transition between the networks during and after the disaster conditions while minimizing service interruptions and preventing network congestion. The interaction of these components ensures that the UE 102 manages disaster roaming efficiently, automatically switches to the PLMN 104 providing disaster roaming services, and transitions back to the RPLMN once the disaster condition ends.

The disaster roaming controller 640 is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor 610 may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 610 may include multiple cores and is configured to execute the instructions stored in the memory 630.

Further, the processor 610 is configured to execute instructions stored in the memory 630 and to perform various processes. The communicator 620 is configured for communicating internally between internal hardware components and with external devices via one or more networks. The memory 630 also stores instructions to be executed by the processor 610. The memory 630 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 630 may, in some examples, be considered a non-transitory storage medium. The term “non-transitory” may indicate that the storage medium is not embodied in a carrier wave or a propagated signal. However, the term “non-transitory” should not be interpreted that the memory 630 is non-movable. In certain examples, a non-transitory storage medium may store data that can, over time, change (e.g., in Random Access Memory (RAM) or cache).

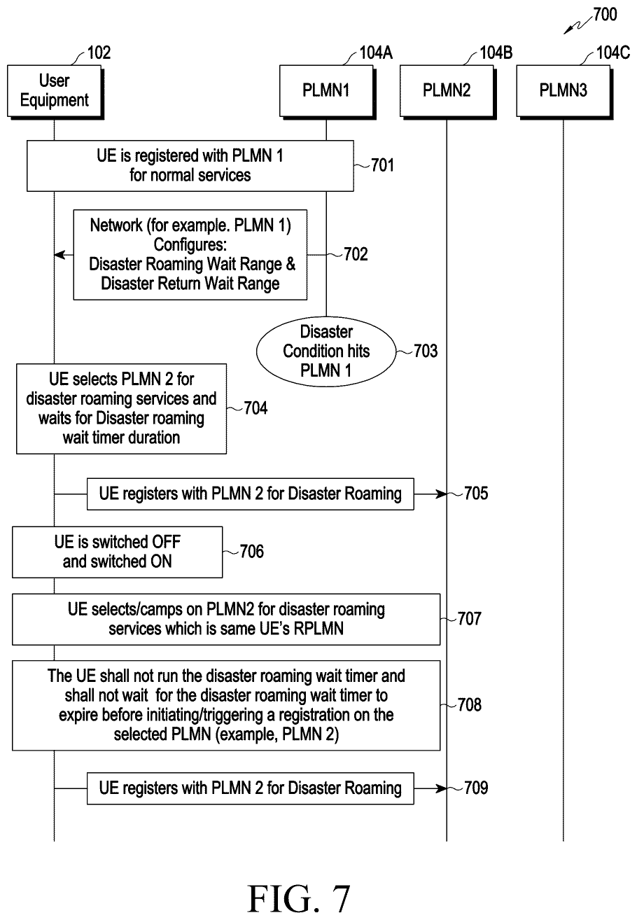

FIG. 7 illustrates a scenario wherein the registered PLMN (RPLMN) is a PLMN 104 with which the MS was registered for the disaster roaming services (i.e., the UE 102 supports MINT and the RPLMN is the forbidden PLMN 104 for the UE 102 on which the UE 102 was registered for the disaster roaming services).

As illustrated in FIG. 7, in step 701, the UE 102 or MS 102 is registered to the PLMN1 104A (for e.g., PLMN-D) for the normal services. In step 702, the UE 102 is configured (for e.g., by PLMN1 104A Network or by the Home PLMN (for e.g., HPLMN of the UE 102) or by any Network/Network Entity) with the disaster roaming wait range and/or disaster return wait range. In step 703, the PLMN1 104A faces the disaster condition or Disaster condition hits PLMN1 104A. The UE 102 supports the MINT services. In step 704, the UE 102 selects the PLMN2 104B for getting the disaster roaming services (for e.g., on behalf of PLMN1 104A or PLMN-D). Upon selecting the PLMN 104 for the disaster roaming (for e.g., PLMN2 104B), if there is a disaster roaming wait range stored in the UE 102, the UE 102 may generate the random number within the disaster roaming wait range and start the timer (for e.g., disaster roaming wait timer) set to the generated random number. While the timer is running, the MS may not initiate registration with the exception of performing the initial registration for the emergency services, in the selected PLMN (for e.g., PLMN2 104B). If performing the initial registration for the emergency services in the selected PLMN, the MS may keep the timer running. Upon expiration of the timer, in step 705, if the MS does not have the emergency PDU session, the MS may initiate registration, if the UE 102 is still camped on the selected PLMN (for e.g., PLMN2 104B). The UE 102 registers on the PLMN2 104B for disaster roaming services. The Registered PLMN (for e.g., RPLMN) of the UE 102 is PLMN2 104B. In step 706, the UE 102 is switched OFF and switched ON. At switched ON, in step 707, the RPLMN of the UE 102 is the PLMN on which the MS was registered for the disaster roaming services (for e.g., PLMN2 104B), and the MS is not registered via non-3GPP access connected to the 5GCN and no allowable PLMN is available and the MS selects the RPLMN (for e.g., PLMN2 104B) or its equivalent PLMN for disaster roaming services. For example, when the UE 102 performs the PLMN search/selection after the switch-ON, and it selects the PLMN on which the UE 102 was registered for the disaster roaming services (for e.g., RPLMN or PLMN2 104B) before switch-OFF). In step 708, the UE 102 may not generate the random number within the disaster roaming wait range and may NOT start the timer with the generated random number. The UE 102 may perform registration or any NAS/AS signalling procedure on the selected PLMN. In step 709, the UE 102 triggers registration or any NAS/AS signalling procedure on the selected PLMN.

The UE 102 supports the MINT and the RPLMN is the forbidden PLMN for the UE 102 on which the UE 102 was registered for the disaster roaming services), at switched ON or recovery from lack of coverage, optionally if Registered PLMN (RPLMN) is present in the UE 102 and, if the Registered PLMN (RPLMN) is a PLMN (for e.g., PLMN2 104B) with which the MS was registered for the disaster roaming services (for e.g., the UE 102 supports MINT and the RPLMN is the forbidden PLMN for the UE 102 on which the UE 102 was registered for disaster roaming services), and optionally if the MS is not registered via the non-3GPP access connected to 5GCN and/or optionally if any allowable PLMN is available and/or optionally if an NG-RAN cell of the RPLMN or any other PLMN does not broadcast the disaster related indication or does not broadcast a “list of one or more PLMN(s) with disaster condition for which disaster roaming services is offered by the available PLMN,” optionally including the MS determined PLMN with disaster condition, then the UE 102 may perform below steps or procedure in any order or combination.

If any allowable PLMN is available for the UE 102 and if the UE 102 or the MS finds and selects the allowable PLMN (for e.g., PLMN1 104A) (for e.g., which is different than the RPLMN (for e.g., PLMN2) or its equivalent PLMN) (for e.g., the UE 102 selects any PLMN, which is an allowable PLMN for the UE 102, optionally it may be MS determined PLMN with disaster condition or it may be PLMN previously with disaster condition), optionally if there is a disaster return wait range stored in the ME/USIM, the UE 102 may not generate the random number within the disaster return wait range and may not start/run the timer (for e.g., disaster return wait timer) set to the generated random number. The UE 102 may not run the disaster return wait timer and may not wait for the disaster return wait timer to expire before initiating/triggering a registration on the selected PLMN (for e.g., PLMN1 104A). The UE 102 may perform registration procedure or any NAS/AS signalling procedure on the selected PLMN.

In another embodiment, if the UE 102 was previously camped for the normal services on the selected PLMN/PLMN+RAT combination or any of the PLMN/PLMN+RAT combination or if the UE 102 needs to start/run the Disaster return wait range/timer for the selected PLMN (optionally selected PLMN+RAT combination) or any of the PLMN(s) (optionally selected PLMN+RAT combination) after the disaster condition has ended, the UE may, optionally, start the Disaster return wait range/timer with the random value generated between 0 and the difference (i.e. remaining time) of the value between previously run timer and the current value of Disaster return wait range/timer.

If any allowable PLMN is available for the UE 102 and if the UE 102 or the MS finds and selects an allowable PLMN (for e.g., PLMN1 104A) (for e.g. which is different than the RPLMN (for e.g., PLMN2 104B) or its equivalent PLMN) (for e.g., the UE selects any PLMN, which is an allowable PLMN for the UE 102, optionally it may be MS determined PLMN with disaster condition or it may be PLMN previously with disaster condition), optionally if there is a disaster return wait range stored in the ME/USIM, and it was not registered on the selected PLMN for normal service and not waited for the time duration of generated random number within the disaster return wait range (for example, after disaster condition/situation had ended, if the UE 102 was not registered on the selected PLMN for normal service (optionally not even once) and the UE 102 has not waited for the time duration of generated random number within the disaster return wait range), the UE 102 may generate a random number within the disaster return wait range and start the timer with the generated random number value. While the timer is running, the UE 102 may not initiate registration on the selected PLMN except if the UE 102 needs to request an emergency PDU session, in which case the UE 102 may initiate the registration procedure for emergency services, set the 5GS registration type IE to “emergency registration” in the REGISTRATION REQUEST message or any NAS signalling message and keep the timer running. Upon expiration of the timer, if the UE 102 does not have the emergency PDU session, the UE 102 may perform the registration procedure for disaster roaming services if still camped on the selected PLMN. Upon expiration of the timer, if the UE 102 has an emergency PDU session when the timer expires, the UE 102 may initiate registration procedure after the release of the emergency PDU session, if the UE 102 is still camped on the selected PLMN.

In an embodiment, the UE 102 being switched ON or recovered from lack of coverage, if the RPLMN is a PLMN with which the MS was registered for disaster roaming services and the UE 102 selects an allowable PLMN for normal services, if the UE 102 has a stored disaster return wait range, the UE 102 may NOT generate the random number within the disaster return wait range and may NOT start the timer with the generated random number value. The UE 102 may perform a registration procedure or any NAS/AS signalling procedure on the selected PLMN.

In an embodiment, the UE 102 being switched ON or recovery from lack of coverage, if the RPLMN is the PLMN with which the MS was registered for disaster roaming services and the UE 102 selects the allowable PLMN for normal services which is same as the MS determined PLMN with disaster condition or optionally same as the PLMN with disaster condition, optionally for which the UE 102 was registered on the RPLMN for disaster roaming services (or optionally same as the equivalent PLMN of the RPLMN of the UE 102), if the UE 102 has a stored disaster return wait range, the UE 102 may NOT generate the random number within the disaster return wait range and may NOT start a timer with the generated random number value. The UE 102 may perform a registration procedure or any NAS/AS signalling procedure on the selected PLMN.

In an embodiment, the UE 102 being switched ON or recovery from lack of coverage, if the RPLMN is the PLMN with which the MS was registered for disaster roaming services and the UE 102 selects the allowable PLMN for normal services which is different/not same as the MS determined PLMN with disaster condition or optionally different/not same as the PLMN with disaster condition, optionally for which UE 102 was registered on the RPLMN for disaster roaming services (or optionally different/not same as the equivalent PLMN of the RPLMN of the UE 102), if the UE 102 has a stored disaster return wait range, the UE 102 may generate the random number within the disaster return wait range and start the timer with the generated random number value. While the timer is running, the UE 102 may not initiate registration on the selected PLMN except if the UE 102 needs to request an emergency PDU session, in which case the UE 102 may initiate the registration procedure for emergency services, set the 5GS registration type IE to “emergency registration” in the REGISTRATION REQUEST message or any NAS signalling message and keep the timer running. Upon expiration of the timer, if the UE 102 does not have the emergency PDU session, the UE 102 may perform the registration procedure for disaster roaming services if still camped on the selected PLMN. Upon expiration of the timer, if the UE 102 has the emergency PDU session when the timer expires, if the UE 102 is still camped on the selected PLMN, the UE 102 may initiate registration procedure after the release of the emergency PDU session.

In an embodiment, the UE 102 being switched ON or recovery from lack of coverage, if the RPLMN is the PLMN with which the MS was registered for disaster roaming services and the UE 102 selects the allowable PLMN for normal services, if the UE 102 has the stored disaster return wait range, the UE 102 may generate the random number within the disaster return wait range and start the timer with the generated random number value. While the timer is running, the UE 102 may not initiate registration on the selected PLMN except if the UE 102 needs to request the emergency PDU session, in which case the UE 102 may initiate the registration procedure for the emergency services, set the 5GS registration type IE to “emergency registration” in the REGISTRATION REQUEST message or any NAS signalling message and keep the timer running. Upon expiration of the timer, if the UE 102 does not have an emergency PDU session, the UE 102 may perform the registration procedure for disaster roaming services if still camped on the selected PLMN. Upon expiration of the timer, if the UE 102 has an emergency PDU session when the timer expires, and if the UE 102 is still camped on the selected PLMN, the UE 102 may initiate registration procedure after the release of the emergency PDU session.

In another embodiment, the PLMN selected by the UE 102 can be at least one of: forbidden PLMN of the UE 102, allowable PLMN of the UE 102, registered PLMN (RPLMN) of the UE 102, MS determined PLMN with disaster condition and/or PLMN previously with disaster condition. The terms “disaster return wait range” and “disaster return wait timer” are used interchangeably and have same meaning in the patent disclosure.

At switch on or recovery from lack of coverage, optionally if Registered PLMN (RPLMN) is present in the UE and, if the Registered PLMN (RPLMN) is a PLMN (for e.g., PLMN2) with which the MS was registered for disaster roaming services (for e.g., the UE supports MINT and the RPLMN is a forbidden PLMN for the UE on which the UE was registered for disaster roaming services), and optionally if the MS is not registered via non-3GPP access connected to 5GCN and/or optionally if no other allowable PLMN is available and/or optionally if an NG-RAN cell of the RPLMN or any other PLMN broadcasts the disaster related indication or a “list of one or more PLMN(s) with disaster condition for which disaster roaming services is offered by the available PLMN,” optionally including the MS determined PLMN with disaster condition, then the UE may perform below steps or procedure in any order or combination:

if the UE or the MS selects the RPLMN (for e.g., PLMN2) or optionally its equivalent PLMN (optionally the UE selects the same RAT as the last registered RAT) (for e.g., the UE selects any PLMN (which is a forbidden PLMN for the UE) for disaster roaming services and the selected PLMN is same as the RPLMN of the UE or optionally same as the equivalent PLMN of the RPLMN of the UE) for disaster roaming services (for e.g., optionally on behalf of PLMN1 or PLMN-D), optionally if there is a disaster roaming wait range stored in the UE (for e.g., ME/USIM), the UE may not generate a random number within the disaster roaming wait range and may not start/run a timer (for e.g., disaster roaming wait timer) set to the generated random number. The UE may not run the disaster roaming wait timer and may not wait for the disaster roaming wait timer to expire before initiating/triggering a registration on the selected PLMN (for e.g., PLMN2). The UE may perform registration procedure or any NAS/AS signalling procedure on the selected PLMN.

In an embodiment, if the UE or the MS selects RPLMN (for e.g., PLMN2) or optionally its equivalent PLMN (optionally the UE selects a RAT different from the last registered RAT (for e.g., the selected RAT is different than the RAT on which the UE was registered on the selected PLMN before switch-OFF), optionally if there is a disaster roaming wait range stored in the UE (for e.g. ME/USIM), the UE may not generate a random number within the disaster roaming wait range and may not start/run a timer (for e.g., disaster roaming wait timer) set to the generated random number. The UE may not run the disaster roaming wait timer and may not wait for the disaster roaming wait timer to expire before initiating/triggering a registration on the selected PLMN (for e.g., PLMN2). The UE may perform registration procedure or any NAS/AS signalling procedure on the selected PLMN.

In an embodiment, if the UE or the MS selects a PLMN (for e.g., any forbidden PLMN of the UE) for disaster roaming services (for e.g., optionally on behalf of PLMN1 or PLMN-D or any other PLMN), optionally if there is a disaster roaming wait range stored in the UE (for e.g. ME/USIM), the UE may not generate a random number within the disaster roaming wait range and may not start/run a timer (for e.g., disaster roaming wait timer) set to the generated random number. The UE may not run the disaster roaming wait timer and may not wait for the disaster roaming wait timer to expire before initiating/triggering a registration on the selected PLMN for disaster roaming services. The UE may perform registration procedure or any NAS/AS signalling procedure on the selected PLMN.

In an embodiment, if the UE or the MS selects a PLMN (for e.g., any forbidden PLMN of the UE) for disaster roaming services (for e.g., optionally on behalf of PLMN1 or PLMN-D or any other PLMN) other/different than the RPLMN or optionally its equivalent PLMN, optionally if there is a disaster roaming wait range stored in the UE (for e.g. ME/USIM), the UE may generate a random number within the disaster roaming wait range and may start/run a timer (for e.g., disaster roaming wait timer) set to the generated random number. The UE may run the disaster roaming wait timer and may wait for the disaster roaming wait timer to expire before initiating/triggering a registration on the selected PLMN for disaster roaming services. While the timer is running, the UE may not initiate registration on the selected PLMN except if the UE needs to request an emergency PDU session, in which case the UE may initiate the registration procedure for emergency services, set the 5GS registration type IE to “emergency registration” in the REGISTRATION REQUEST message or any NAS signalling message and keep the timer running. Upon expiration of the timer, if the UE does not have an emergency PDU session, the UE may perform a registration procedure for disaster roaming services if still camped on the selected PLMN. Upon expiration of the timer, if the UE has an emergency PDU session when the timer expires, the UE may initiate registration procedure after the release of the emergency PDU session, if the UE is still camped on the selected PLMN.

In yet another embodiment, if the UE was previously registered for disaster roaming services on the selected PLMN/selected PLMN+RAT combination or any of the PLMN/PLMN+RAT combination or if the UE has started/run the Disaster roaming wait range/timer for the selected PLMN (optionally selected PLMN+RAT combination) or any of the PLMN(s) (optionally selected PLMN+RAT combination) providing disaster roaming services any time after the disaster condition has occurred, the UE may, optionally, start a Disaster roaming wait range/timer with a random value generated between 0 and the difference (i.e., remaining time) of the value between previously run timer and the current value of Disaster roaming wait range/timer.

In yet another embodiment, if the UE was previously registered for disaster roaming services on the selected PLMN/PLMN+RAT combination or any of the PLMN/PLMN+RAT combination or if the UE has started/run the Disaster roaming wait range/timer for the selected PLMN (optionally selected PLMN+RAT combination) or any of the PLMN(s) (optionally selected PLMN+RAT combination) providing disaster roaming services any time after the disaster condition has occurred, the UE may, optionally, start a Disaster roaming wait range/timer with a random value generated between 0 and the difference (i.e., remaining time) of the value between a previously run timer and the current value of Disaster roaming wait range/timer.

In an embodiment, if the UE or the MS selects a PLMN (for e.g., any forbidden PLMN of the UE) for disaster roaming services and optionally if there is a disaster roaming wait range stored in the UE (for e.g., ME/USIM) and it was not registered on the selected PLMN for disaster roaming service and not waited for the time duration of generated random number within the disaster roaming wait range (for example, during disaster condition/situation, if the UE was not registered on the selected PLMN for disaster roaming service (optionally not even once) and the UE has not waited for the time duration of generated random number within the disaster roaming wait range), the UE may generate a random number within the disaster roaming wait range and may start/run a timer (for e.g., disaster roaming wait timer) set to the generated random number. The UE may run the disaster roaming wait timer and may wait for the disaster roaming wait timer to expire before initiating/triggering a registration on the selected PLMN for disaster roaming services.

In an embodiment, at switch on or recovery from lack of coverage, if the RPLMN is a PLMN with which the MS was registered for disaster roaming services and the UE selects a PLMN for disaster roaming, if the UE has a stored disaster roaming wait range, the UE may NOT generate a random number within the disaster roaming wait range and may NOT start a timer with the generated random number. The UE may perform registration procedure or any NAS/AS signalling procedure on the selected PLMN.

In an embodiment, at switch on or recovery from lack of coverage, if the RPLMN is a PLMN with which the MS was registered for disaster roaming services and the UE selects a PLMN for disaster roaming which is the same as the RPLMN of the UE (or optionally same as the equivalent PLMN of the RPLMN of the UE), if the UE has a stored disaster roaming wait range, the UE may NOT generate a random number within the disaster roaming wait range and may NOT start a timer with the generated random number. The UE may perform registration procedure or any NAS/AS signalling procedure on the selected PLMN.

In an embodiment, at switch on or recovery from lack of coverage, if the RPLMN is a PLMN with which the MS was registered for disaster roaming services and the UE selects a PLMN for disaster roaming which is different or not the same as the RPLMN of the UE (or optionally same as the equivalent PLMN of the RPLMN of the UE), if the UE has a stored disaster roaming wait range, the UE may generate a random number within the disaster roaming wait range and start a timer with the generated random number. While the timer is running, the UE may not initiate registration on the selected PLMN except if the UE needs to request an emergency PDU session, in which case the UE may initiate the registration procedure for emergency services, set the 5GS registration type IE to “emergency registration” in the REGISTRATION REQUEST message or any NAS signalling message and keep the timer running. Upon expiration of the timer, if the UE does not have an emergency PDU session, the UE may perform a registration procedure for disaster roaming services if still camped on the selected PLMN. Upon expiration of the timer, if the UE has an emergency PDU session when the timer expires, the UE may initiate registration procedure after the release of the emergency PDU session, if the UE is still camped on the selected PLMN.

In an embodiment, at switch on or recovery from lack of coverage, if the RPLMN is a PLMN with which the MS was registered for disaster roaming services and the UE selects a PLMN for disaster roaming, if the UE has a stored disaster roaming wait range, the UE may generate a random number within the disaster roaming wait range and start a timer with the generated random number. While the timer is running, the UE may not initiate registration on the selected PLMN except if the UE needs to request an emergency PDU session, in which case the UE may initiate the registration procedure for emergency services, set the 5GS registration type IE to “emergency registration” in the REGISTRATION REQUEST message or any NAS signalling message and keep the timer running. Upon expiration of the timer, if the UE does not have an emergency PDU session, the UE may perform a registration procedure for disaster roaming services if still camped on the selected PLMN. Upon expiration of the timer, if the UE has an emergency PDU session when the timer expires, the UE may initiate registration procedure after the release of the emergency PDU session, if the UE is still camped on the selected PLMN.

In another embodiment, the PLMN selected by the UE can be at least one of: forbidden PLMN of the UE, allowable PLMN of the UE, registered PLMN (RPLMN) of the UE, MS determined PLMN with disaster condition and/or PLMN previously with disaster condition.

The term disaster return wait timer refers to a random number generated by the UE within the disaster return wait range and a timer that is started with the generated random number value.

The terms disaster roaming wait range and disaster roaming wait timer are used interchangeably and have the same meaning.

The term disaster roaming wait timer refers to a random number generated by the UE within the disaster roaming wait range and a timer that is started with the generated random number value.

In this embodiment, the terms UE may not generate a random number, the UE may not run the timer (for e.g., any timer such as disaster roaming wait timer or disaster return wait timer), the UE may not wait for the timer to expire and the UE may consider the timer value as Zero (0) are used interchangeably and have the same meaning.

The solutions defined in this embodiment are explained using switch-OFF and switch-ON as examples. The solution applies to other cases such as when USIM is removed, USIM is removed and/or (re)-inserted, USIM is inserted, the UE is recovering from lack of coverage and other such cases.

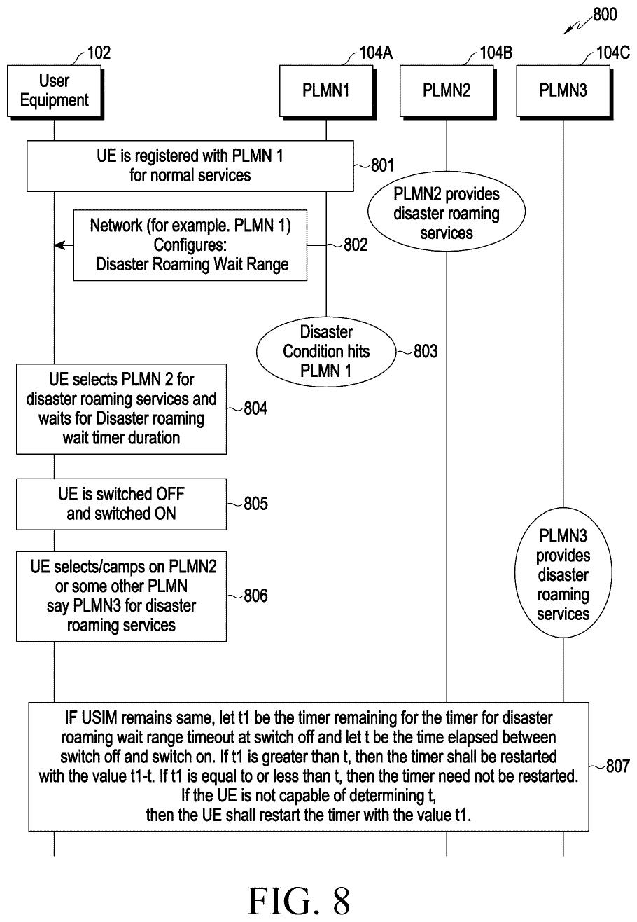

FIG. 8 illustrates a disaster timer handling after the power off of the UE. Pre-condition are PLMN2 104B and PLMN3 104C providing the disaster roaming services. As illustrated in FIG. 8, at step 801, the UE 102 is registered with PLMN1 104A for the normal services. At step 802, the network (for e.g., PLMN1 104A) configures disaster roaming wait range. At step 803, the disaster condition hits in PLMN1 104A. At step 804, the UE 102 selects PLMN2 104B for disaster roaming services and waits for Disaster roaming wait timer duration.

At step 805, the UE 102 is switched OFF and switched ON. At step 806, the UE 102 selects/camps on the PLMN2 104B or some other PLMN say PLMN3 104C for disaster roaming services. At step 807, when USIM remains same, let t1 be the time remaining for the timer for disaster roaming wait range timeout at switched OFF and let t be the time elapsed between switched OFF and switched ON. If t1 is greater than t, then the timer may be restarted with the value t1−t. If t1 is equal to or less than t, then the timer need not be restarted. If the UE 102 is not capable of determining t, then the UE 102 may restart the timer with the value t1.

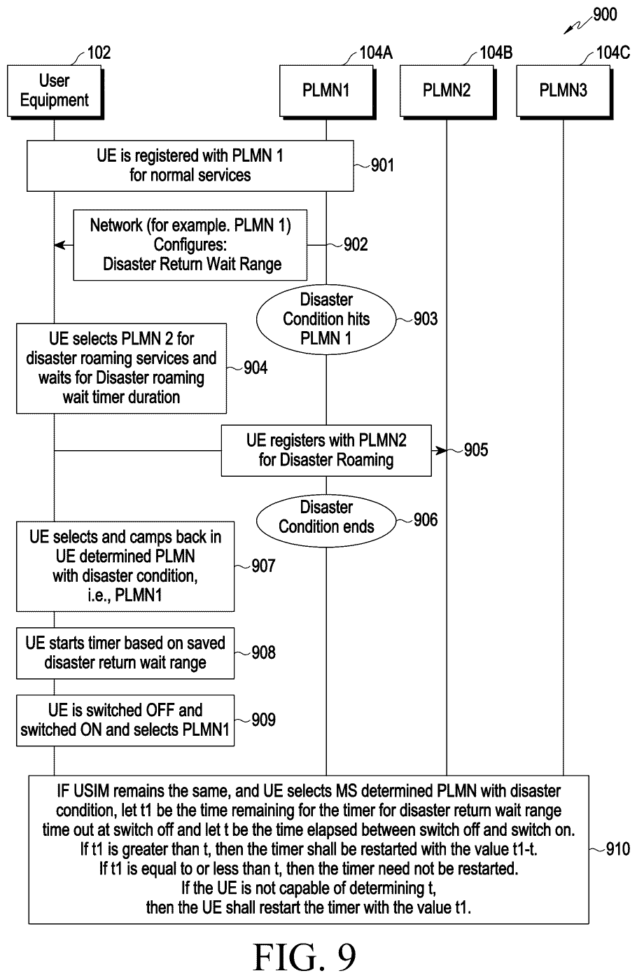

FIG. 9 illustrates a disaster timer handling after power off of the UE 102. Pre-condition, wherein PLMN1 104A is MS determined PLMN with disaster condition, PLMN3 104C is any other allowable PLMN. At step 901, the UE 102 is registered with PLMN1 104A for normal services. At step 902, the network (for e.g. PLMN1 104A) configures the disaster return wait range. At step 903, the disaster condition hits in the PLMN1 104A. At step 904, the UE 102 selects PLMN2 104B for disaster roaming services and waits for Disaster roaming wait timer duration. At step 905, the UE 102 registers in PLMN2 104B for disaster roaming services. At step 906, the disaster condition ends. At step 907, the UE 102 selects & camps back in MS determined PLMN with disaster condition, i.e. PLMN1 104A. At step 908, the UE 102 starts the timer based on saved disaster return wait range. At step 909, the UE 102 is switched OFF and switched ON and selects MS determined PLMN with disaster condition which is PLMN1 104A. At step 910, when the USIM remains the same, and the UE 102 selects MS determined PLMN with disaster condition, let t1 be the time remaining for the timer for disaster return wait range timeout at switched OFF and let t be the time elapsed between switched OFF and switched ON. If t1 is greater than t, then the timer may be restarted with the value t1−t. If t1 is equal to or less than t, then the timer need not be restarted. If the UE 102 is not capable of determining t, then the UE 102 may restart the timer with the value t1.

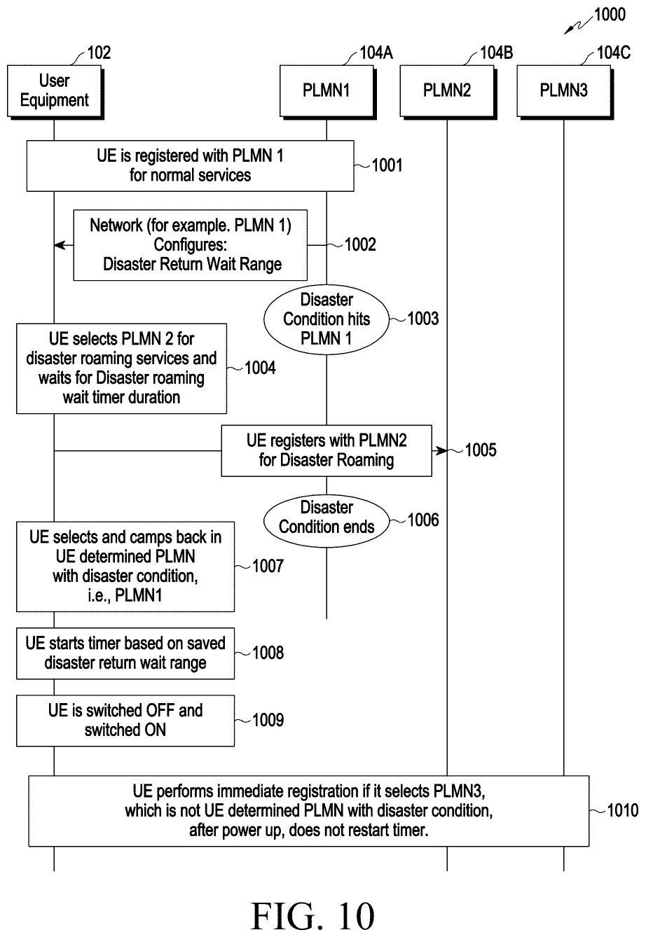

FIG. 10 illustrates a disaster timer handling after power off of the UE 102. Pre-condition, wherein the PLMN1 104A is MS determined PLMN with disaster condition, PLMN3 104C is any other allowable PLMN. At step 1001, the UE 102 is registered with PLMN1 104A for normal services. At step 1002, the network (for e.g., PLMN1 104A) configures disaster return wait range. At step 1003, the disaster condition hits in PLMN1 104A. At step 1004, the UE 102 selects PLMN2 104B for disaster roaming services and waits for Disaster roaming wait timer duration. At step 1005, the UE 102 registers in PLMN2 104B for disaster roaming services. At step 1006, the disaster condition ends. At step 1007, the UE 102 selects & camps back in MS determined PLMN with disaster condition, i.e., PLMN1 104A. At step 1008, the UE 102 starts timer based on saved disaster return wait range. At step 1009, the UE 102 is switched OFF and switched ON. At step 1010, the UE 102 performs immediate registration if it selects PLMN3 104C, which is not MS determined PLMN with disaster condition, after power up, does not restart timer.

In an embodiment, if the UE 102 is running a Disaster wait timer (for e.g. timer for Disaster roaming wait range or timer for Disaster return wait range) and the UE 102 is switched Off and then the UE 102 is switched ON, the UE 102 may apply and use the methods described in this embodiment if the USIM remains the same. If the USIM is different after switch-ON, the UE 102 may not start the timer and register on the selected PLMN immediately. In an embodiment, if the USIM is different after switch-ON, the UE 102 may start the timer with the stored remaining value. In an embodiment, if the USIM is different after switch-ON, the UE 102 may start the timer with the computed remaining value by subtracting the time elapsed between switch off and switch on from the stored remaining value. In an embodiment, if the USIM is different after switch-ON, the UE 102 may start the timer with the reset value or a default value.

In an embodiment, if the UE 102 is running a Disaster wait timer (for e.g. timer for Disaster roaming wait range or timer for Disaster return wait range) and UE 102 is switched Off and then the UE 102 is switched ON, the UE 102 may apply and use the methods described in this embodiment if the selected PLMN before switch-OFF and after switch-ON remains the same. If the selected PLMN is different after switch-ON, the UE 102 may not start the timer and register on the selected PLMN immediately. In an embodiment, if the selected PLMN is different after switch-ON, the UE 102 may start the timer with the stored remaining value. In an embodiment, if the selected PLMN is different after switch-ON, the UE 102 may start the timer with the computed remaining value by subtracting the time elapsed between switch off and switch on from the stored remaining value. In an embodiment, if the selected PLMN is different after switch-ON, the UE 102 may start the timer with the reset value or a default value.

The term “disaster return wait timer” refers to a random number generated by the UE 102 within the disaster return wait range and a timer that is started with the generated random number value.

The terms “disaster roaming wait range” and “disaster roaming wait timer” are used interchangeably and have the same meaning.

The term “disaster roaming wait timer” refers to a random number generated by the UE 102 within the disaster roaming wait range and the timer that is started with the generated random number value.

In another embodiment, the terms “UE may not generate the random number,” the “UE may not run the timer” (for e.g., any timer such as disaster roaming wait timer or disaster return wait timer), the UE 102 may not wait for the timer to expire and the UE 102 may consider the timer value as Zero (0) are used interchangeably and have the same meaning.

The embodiment uses switch-OFF and switch-ON as examples. The embodiment applies to other cases such as when USIM is removed, USIM is removed and/or (re)-inserted, USIM is inserted, the UE is recovering from lack of coverage and other such cases. In a scenario, wherein the UE is transitioning from normal service to disaster roaming service.

In an embodiment, the UE or MS is registered/camped to PLMN1 (for e.g. PLMN-D) for normal services when disaster conditions hit. The UE is configured with disaster return wait range. When disaster condition is triggered, the UE selects PLMN2 (for e.g. on behalf of PLMN1 i.e. PLMN-D) for disaster roaming services and waits for Disaster roaming wait timer duration. The UE registers in PLMN2 for disaster roaming services. When the disaster condition ends, the UE selects and camps back in MS determined PLMN with disaster condition, i.e., PLMN1. The UE starts timer based on saved disaster return wait range. The UE is switched OFF and switched ON in the meantime. When the USIM remains the same, and the UE selects MS determined PLMN with disaster condition, let t1 be the time remaining for the timer for disaster return wait range timeout at switch off and let t be the time elapsed between switch off and switch on. If t1 is greater than t, then the timer may be restarted with the value t1−t. If t1 is equal to or less than t, then the timer need not be restarted. If the UE is not capable of determining t, then the UE may restart the timer with the value t1. In an embodiment, the UE performs immediate registration if it selects PLMN3, which is not MS determined PLMN with disaster condition, after power up, does not restart timer.

In another embodiment, the terms UE 102 may not generate a random number, the UE 102 may not run the timer (for e.g., any timer such as disaster roaming wait timer or disaster return wait timer), the UE 102 may not wait for the timer to expire and the UE 102 may consider the timer value as Zero (0) are used interchangeably and have the same meaning.

The embodiments are explained using switch-OFF and switch-ON as an example. The solutions disclosed herein are applicable to all/other cases such as when the UE 102 is Switched OFF and/or switch-ON, or when the UE 102 is switched ON, or when USIM is removed, or when USIM is removed and/or (re)-inserted, or when USIM is inserted, or when the UE 102 is recovering from lack of coverage and other such cases.

The disaster roaming/return wait range stored in the UE 102 as mentioned in the embodiment can be stored in USIM/ME.

In this embodiment, the PLMN selected by the UE 102 can be at least one of: forbidden PLMN of the UE 102, allowable PLMN of the UE 102, registered PLMN (RPLMN) of the UE 102, MS determined PLMN with disaster condition and/or PLMN previously with disaster condition.

In an embodiment, At switched ON or recovery from lack of coverage, optionally if Registered PLMN (RPLMN) is present in the UE 102 and, if the Registered PLMN (RPLMN) is a PLMN (for e.g., PLMN2 104B) with which the MS was registered for disaster roaming services (for e.g., the UE 102 supports MINT and the RPLMN is a forbidden PLMN for the UE 102 on which the UE 102 was registered for disaster roaming services), and optionally if the MS is not registered via non-3GPP access connected to 5GCN and/or optionally if no other allowable PLMN is available and/or optionally if an NG-RAN cell of the RPLMN or any other PLMN broadcasts the disaster related indication or a “list of one or more PLMN(s) with disaster condition for which disaster roaming services is offered by the available PLMN,” optionally including the MS determined PLMN with disaster condition, then the UE 102 may perform below steps or procedure in any order or combination.

If the UE 102 or the MS selects the RPLMN (for e.g., PLMN2 104B) or optionally its equivalent PLMN (optionally the UE 102 selects the same RAT as the last registered RAT) (for e.g., the UE 102 selects any PLMN (which is a forbidden PLMN for the UE 102) for disaster roaming services and the selected PLMN is same as the RPLMN of the UE 102 or optionally same as the equivalent PLMN of the RPLMN of the UE 102) for disaster roaming services (for e.g., optionally on behalf of PLMN1 104A or PLMN-D), optionally if there is a disaster roaming wait range stored in the UE 102 (for e.g., ME/USIM), the UE 102 may not generate a random number within the disaster roaming wait range and may not start/run a timer (for e.g., disaster roaming wait timer) set to the generated random number. The UE 102 may not run the disaster roaming wait timer and may not wait for the disaster roaming wait timer to expire before initiating/triggering a registration on the selected PLMN (for e.g., PLMN2 104B). The UE 102 may perform registration procedure or any NAS/AS signalling procedure on the selected PLMN. In an embodiment, if the UE 102 or the MS selects RPLMN (for e.g., PLMN2 104B) or optionally its equivalent PLMN (optionally the UE 102 selects a RAT different from the last registered RAT (for e.g., the selected RAT is different than the RAT on which the UE 102 was registered on the selected PLMN before switch-OFF), optionally if there is a disaster roaming wait range stored in the UE 102 (for e.g. ME/USIM), the UE 102 may not generate a random number within the disaster roaming wait range and may not start/run a timer (for e.g., disaster roaming wait timer) set to the generated random number. The UE 102 may not run the disaster roaming wait timer and may not wait for the disaster roaming wait timer to expire before initiating/triggering a registration on the selected PLMN (for e.g., PLMN2 104B). The UE 102 may perform registration procedure or any NAS/AS signalling procedure on the selected PLMN.

In an embodiment, if the UE 102 or the MS selects a PLMN (for e.g., any forbidden PLMN of the UE 102) for disaster roaming services (for e.g., optionally on behalf of PLMN1 104A or PLMN-D or any other PLMN), optionally if there is a disaster roaming wait range stored in the UE 102 (for e.g. ME/USIM), the UE 102 may not generate a random number within the disaster roaming wait range and may not start/run a timer (for e.g., disaster roaming wait timer) set to the generated random number. The UE 102 may not run the disaster roaming wait timer and may not wait for the disaster roaming wait timer to expire before initiating/triggering a registration on the selected PLMN for disaster roaming services. The UE 102 may perform registration procedure or any NAS/AS signalling procedure on the selected PLMN.

In an embodiment, if the UE 102 or the MS selects a PLMN (for e.g., any forbidden PLMN of the UE 102) for disaster roaming services (for e.g., optionally on behalf of PLMN1 104A or PLMN-D or any other PLMN) other/different than the RPLMN or optionally its equivalent PLMN, optionally if there is a disaster roaming wait range stored in the UE 102 (for e.g. ME/USIM), the UE 102 may generate a random number within the disaster roaming wait range and may start/run a timer (for e.g., disaster roaming wait timer) set to the generated random number. The UE 102 may run the disaster roaming wait timer and may wait for the disaster roaming wait timer to expire before initiating/triggering a registration on the selected PLMN for disaster roaming services. While the timer is running, the UE 102 may not initiate registration on the selected PLMN except if the UE 102 needs to request an emergency PDU session, in which case the UE 102 may initiate the registration procedure for emergency services, set the 5GS registration type IE to “emergency registration” in the REGISTRATION REQUEST message or any NAS signalling message and keep the timer running. Upon expiration of the timer, if the UE 102 does not have an emergency PDU session, the UE 102 may perform a registration procedure for disaster roaming services if still camped on the selected PLMN. Upon expiration of the timer, if the UE 102 has an emergency PDU session when the timer expires, the UE 102 may initiate registration procedure after the release of the emergency PDU session, if the UE 102 is still camped on the selected PLMN.

In yet another embodiment, if the UE 102 was previously registered for disaster roaming services on the selected PLMN/selected PLMN+RAT combination or any of the PLMN/PLMN+RAT combination or if the UE 102 has started/run the Disaster roaming wait range/timer for the selected PLMN (optionally selected PLMN+RAT combination) or any of the PLMN(s) (optionally selected PLMN+RAT combination) providing disaster roaming services any time after the disaster condition has occurred, the UE 102 may, optionally, start a Disaster roaming wait range/timer with a random value generated between 0 and the difference (i.e., remaining time) of the value between previously run timer and the current value of Disaster roaming wait range/timer In yet another embodiment, if the UE 102 was previously registered for disaster roaming services on the selected PLMN/PLMN+RAT combination or any of the PLMN/PLMN+RAT combination or if the UE 102 has started/run the Disaster roaming wait range/timer for the selected PLMN (optionally selected PLMN+RAT combination) or any of the PLMN(s) (optionally selected PLMN+RAT combination) providing disaster roaming services any time after the disaster condition has occurred, the UE 102 may, optionally, start a Disaster roaming wait range/timer with a random value generated between 0 and the difference (i.e., remaining time) of the value between a previously run timer and the current value of Disaster roaming wait range/timer.

In an embodiment, if the UE 102 or the MS selects a PLMN (for e.g., any forbidden PLMN of the UE 102) for disaster roaming services and optionally if there is a disaster roaming wait range stored in the UE 102 (for e.g., ME/USIM) and it was not registered on the selected PLMN for disaster roaming service and not waited for the time duration of generated random number within the disaster roaming wait range (for example, during disaster condition/situation, if the UE 102 was not registered on the selected PLMN for disaster roaming service (optionally not even once) and the UE 102 has not waited for the time duration of generated random number within the disaster roaming wait range), the UE 102 may generate a random number within the disaster roaming wait range and may start/run a timer (for e.g., disaster roaming wait timer) set to the generated random number. The UE 102 may run the disaster roaming wait timer and may wait for the disaster roaming wait timer to expire before initiating/triggering a registration on the selected PLMN for disaster roaming services.

In an embodiment, at switched ON or recovery from lack of coverage, if the RPLMN is a PLMN with which the MS was registered for disaster roaming services and the UE 102 selects a PLMN for disaster roaming, if the UE 102 has a stored disaster roaming wait range, the UE 102 may NOT generate a random number within the disaster roaming wait range and may NOT start a timer with the generated random number. The UE 102 may perform registration procedure or any NAS/AS signalling procedure on the selected PLMN.

In an embodiment, at switch on or recovery from lack of coverage, if the RPLMN is a PLMN with which the MS was registered for disaster roaming services and the UE 102 selects a PLMN for disaster roaming which is the same as the RPLMN of the UE 102 (or optionally same as the equivalent PLMN of the RPLMN of the UE 102), if the UE 102 has a stored disaster roaming wait range, the UE 102 may NOT generate a random number within the disaster roaming wait range and may NOT start a timer with the generated random number. The UE 102 may perform registration procedure or any NAS/AS signalling procedure on the selected PLMN.

In an embodiment, at switch on or recovery from lack of coverage, if the RPLMN is a PLMN with which the MS was registered for disaster roaming services and the UE 102 selects a PLMN for disaster roaming which is different or not the same as the RPLMN of the UE 102 (or optionally same as the equivalent PLMN of the RPLMN of the UE 102), if the UE 102 has a stored disaster roaming wait range, the UE 102 may generate a random number within the disaster roaming wait range and start a timer with the generated random number. While the timer is running, the UE 102 may not initiate registration on the selected PLMN except if the UE 102 needs to request an emergency PDU session, in which case the UE 102 may initiate the registration procedure for emergency services, set the 5GS registration type IE to “emergency registration” in the REGISTRATION REQUEST message or any NAS signalling message and keep the timer running. Upon expiration of the timer, if the UE 102 does not have an emergency PDU session, the UE 102 may perform a registration procedure for disaster roaming services if still camped on the selected PLMN. Upon expiration of the timer, if the UE 102 has an emergency PDU session when the timer expires, the UE 102 may initiate registration procedure after the release of the emergency PDU session, if the UE 102 is still camped on the selected PLMN.

In an embodiment, at switch on or recovery from lack of coverage, if the RPLMN is a PLMN with which the MS was registered for disaster roaming services and the UE 102 selects a PLMN for disaster roaming, if the UE 102 has a stored disaster roaming wait range, the UE 102 may generate a random number within the disaster roaming wait range and start a timer with the generated random number. While the timer is running, the UE 102 may not initiate registration on the selected PLMN except if the UE 102 needs to request an emergency PDU session, in which case the UE 102 may initiate the registration procedure for emergency services, set the 5GS registration type IE to “emergency registration” in the REGISTRATION REQUEST message or any NAS signalling message and keep the timer running. Upon expiration of the timer, if the UE 102 does not have an emergency PDU session, the UE 102 may perform a registration procedure for disaster roaming services if still camped on the selected PLMN. Upon expiration of the timer, if the UE 102 has an emergency PDU session when the timer expires, the UE 102 may initiate registration procedure after the release of the emergency PDU session, if the UE 102 is still camped on the selected PLMN.

In this embodiment, the PLMN selected by the UE 102 can be at least one of: forbidden PLMN of the UE 102, allowable PLMN of the UE 102, registered PLMN (RPLMN) of the UE 102, MS determined PLMN with disaster condition and/or PLMN previously with disaster condition.

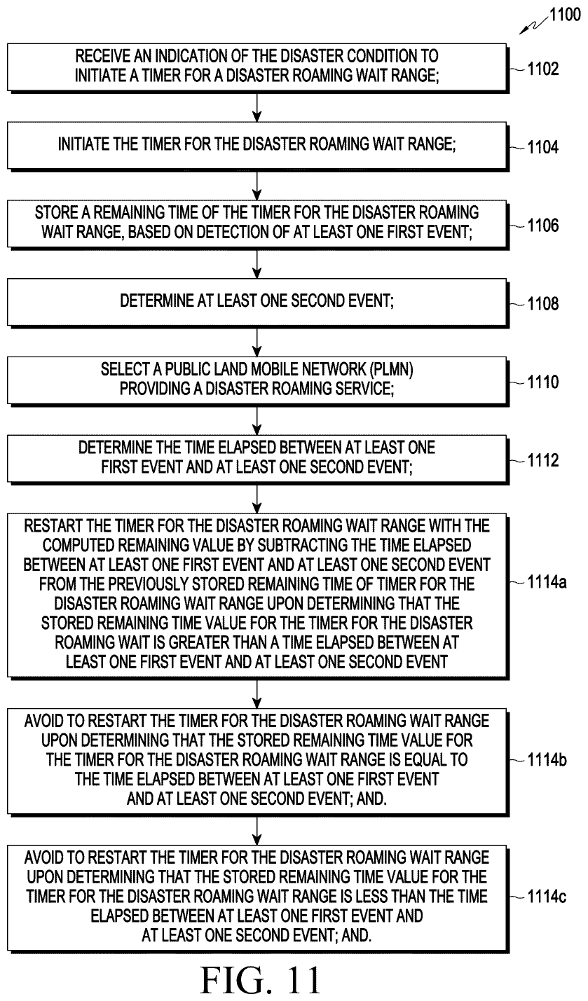

FIG. 11 illustrates a method 1100 for managing the disaster condition in the UE 102 in the network while receiving an indication to initiate a disaster roaming wait range timer. As depicted in FIG. 11, in step 1102, the UE 102 may receive an indication of the disaster condition to initiate a disaster roaming wait range timer. In step 1104, the UE 102 may initiate the timer for the disaster roaming wait range. In step 1106, the UE 102 may store a remaining time of the timer for the disaster roaming wait range, based on detection of at least one first event. In step 1108, the UE 102 may determine at least one second event. In step 1110, the UE 102 may select a public land mobile network (PLMN) providing a disaster roaming service. In step 1112, the UE 102 may determine the time elapsed between at least one first event and at least one second event. In step 1114a, the UE 102 may restart the timer for the disaster roaming wait range with the computed remaining value by subtracting the time elapsed between at least one first event and at least one second event from the previously stored remaining time of the timer for the disaster roaming wait range upon determining that the stored remaining time value for the timer for the disaster roaming wait range is greater than a time elapsed between at least one first event and at least one second event. In step 1114b, the UE avoid restarting the timer for the disaster roaming wait range upon determining that the stored remaining time value for the timer for the disaster roaming wait range is equal to the time elapsed between at least one first event and at least one second event. In step 1114c, the UE avoid restarting the timer for the disaster roaming wait range upon determining that the stored remaining time value for the timer for the disaster roaming wait range is less than the time elapsed between at least one first event and at least one second event.

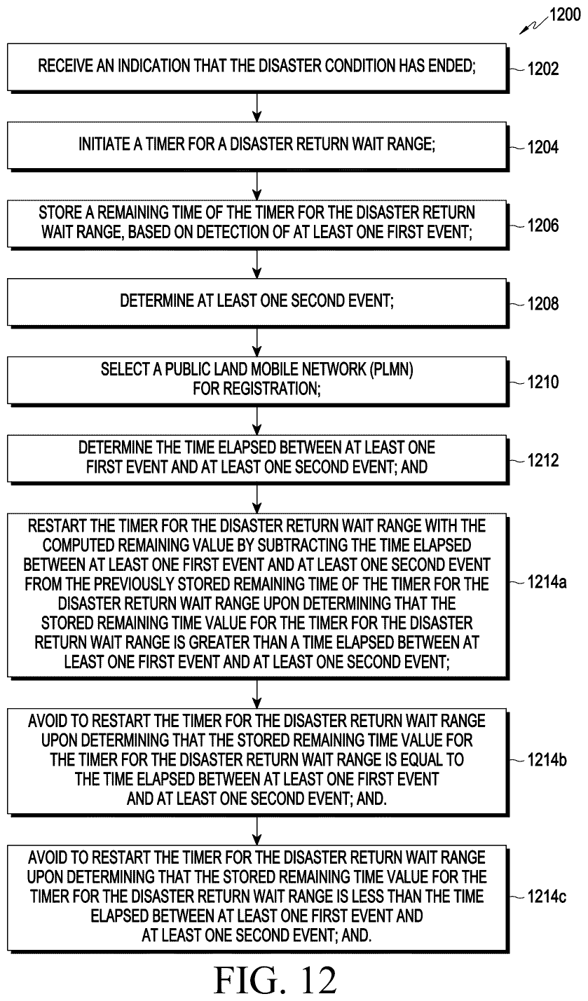

FIG. 12 illustrates a method 1200 for managing the disaster condition in the UE 102. In step 1202, the UE 102 may receive an indication that the disaster condition has ended. In step 1204, the UE 102 may initiate a timer for a disaster return wait range. In step 1206, the UE 102 may store a remaining time of the timer for the disaster return wait range timer, based on detection of at least one first event. In step 1208, the UE 102 may determine at least one second event. In step 1210, the UE 102 may select a public land mobile network (PLMN) for registration. In step 1212, the UE 102 may determine the time elapsed between at least one first event and at least one second event. In step 1214a, the UE 102 may restart the timer for the disaster return wait range timer with the computed remaining value by subtracting the time elapsed between at least one first event and at least one second event from the previously stored remaining time of the timer for the disaster return wait range upon determining that the stored remaining time value for the timer for the disaster return wait range is greater than the time elapsed between at least one first event and at least one second event. In step 1214b, the UE 102 may avoid restarting the timer for the disaster return wait range upon determining that the stored remaining time value for the timer for the disaster return wait range is equal to the time elapsed between at least one first event and at least one second event. In step 1214c, the UE may avoid restarting the timer for the disaster return wait range upon determining that the stored remaining time value for the timer for the disaster return wait range is less than the time elapsed between at least one first event and at least one second event.

The various actions, acts, blocks, steps, or the like in the flow charts/diagrams (1100-1200) may be performed in the order presented, in a different order or simultaneously. Further, in some embodiments, some of the actions, acts, blocks, steps, or the like may be omitted, added, modified, skipped, or the like without departing from the scope of the disclosure.

The embodiments disclosed herein can be implemented through at least one software program running on at least one hardware device and performing network management functions to control the network elements. The elements include blocks which can be at least one of a hardware device, or a combination of hardware device and software module.

The embodiments disclosed herein describe a method and the UE for managing condition in the UE. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., very high-speed integrated circuit hardware description language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the disclosure may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

Although the present disclosure has been described with various embodiments, various changes and modifications may be suggested to one skilled in the art. It is intended that the present disclosure encompass such changes and modifications as fall within the scope of the appended claims.

What is claimed is:

1. A method by a user equipment (UE) for managing a condition, the method comprising:
initiating a timer for disaster wait range; and
in case that the UE is switched off when the timer is running, and that the UE is switched on after the UE is switched off, wherein a universal subscriber identity module (USIM) in the UE remains as same, and the UE selects a public land mobile network (PLMN) for a disaster roaming:
identifying a first time remaining for the timer for timeout at switch off,
identifying a second time related to a time between switching off and switching on, and
determining whether to restart the timer based on the first time and the second time.

2. The method of claim 1, wherein determining whether to restart the timer further comprises:
in case that the first time is greater than the second time, restarting the timer with a value obtained by subtracting the second time from the first time.

3. The method of claim 1, wherein determining whether to restart the timer further comprises:
in case that the first time is equal to or less than the second time, avoiding restarting the timer.

4. The method of claim 1, wherein the timer is for one of a disaster roaming wait range and a disaster return wait range.

5. The method of claim 1, wherein determining whether to restart the timer further comprises:
in case that the UE is not capable of determining the second time, restarting the timer with a value of the first time.

6. The method of claim 1, further comprising:
prohibiting a registration with the selected PLMN till the timer has expired.

7. The method of claim 1, further comprising:
receiving an indication of the condition from at least one of a network entity, a broadcast message, and a preconfigured setting in the UE.

8. The method of claim 1, wherein determining whether to restart the timer is performed in case that the USIM is removed from the UE.

9. The method of claim 1, wherein determining whether to restart the timer is performed in case that a same USIM is reinserted in the UE.

10. A user equipment (UE), comprising:
a transceiver;
a memory; and
at least one processor coupled to the transceiver and the memory, and configured to:
initiate a timer for disaster wait range,
in case that the UE is switched off when the timer is running, and that the UE is switched on after the UE is switched off, wherein a universal subscriber identity module (USIM) in the UE remains as same and the UE selects a public land mobile network (PLMN) for a disaster roaming:
identify a first time remaining for the timer for timeout at switch off,
identify a second time related to a time between switching off and switching on, and
determine whether to restart the timer based on the first time and the second time.

11. The UE of claim 10, wherein the at least one processor is further configured to:
in case that the first time is greater than the second time, restart the timer with a value obtained by subtracting the second time from the first time.

12. The UE of claim 10, wherein the at least one processor is further configured to:
in case that the first time is equal to or less than the second time, avoid restarting the timer.

13. The UE of claim 10, wherein the timer is for one of a disaster roaming wait range and a disaster return wait range.

14. The UE of claim 10, wherein the at least one processor is further configured to:
in case that the UE is not capable of determining the second time, restart the timer with a value of the first time.

15. The UE of claim 10, wherein the at least one processor is further configured to:
prohibit a registration with the selected PLMN till the timer has expired.

16. The UE of claim 10, wherein the at least one processor is further configured to:
receive an indication of a condition from at least one of a network entity, a broadcast message, and a preconfigured setting in the UE.

17. The UE of claim 10, wherein determining whether to restart the timer is performed when the USIM is removed from the UE.

18. The UE of claim 10, wherein determining whether to restart the timer is performed when a undisturbed USIM is reinserted in the UE.
